(19) United States
(12) Patent Application Publication
(10) Pub. No.: US 2007/0076577 A1
(43) Pub. Date: Apr. 5, 2007

(54) Mount Structure, Electro-Optical Device, Method of Manufacturing Electro-Optical Device, and Electronic Apparatus

(75) Inventor: Kazuaki Furuichi, Nagano-ken (JP)

Correspondence Address: LOWE HAUPTMAN BERNER, LLP, 1700 DIAGONAL ROAD, SUITE 300, ALEXANDRIA, VA, 22314, US

(73) Assignee: SANYO EPSON IMAGING DEVICES CORP., Tokyo (JP)

(21) Appl. No.: 11/463,676

(22) Filed: Aug. 10, 2006

(30) Foreign Application Priority Data
Sep. 21, 2005 (JP) 2005-273308

(51) Int. Cl. G11B 7/24

(52) U.S. Cl. 369/275.4

(57) ABSTRACT

Provided is a mount structure including: a board; a conductive layer disposed on the board; a protection layer that is disposed on at least the conductive layer, and has first and second apertures disposed within a region in which the conductive layer is disposed; and an electronic component that is mounted on the board, and has a terminal electrically connected to the conductive layer in a region surrounded by a fringe of the first aperture, wherein a region surrounded by a fringe of the second aperture is an alignment mark that is used to match the location of the terminal of the electronic apparatus to the location of the first aperture.

### BACKGROUND

1. Technical Field

The present invention relates to a mount structure used in personal computers, mobile phones, or the like, an electro-optical device using the mount structure, a method of manufacturing the electro-optical device, and an electronic apparatus using the electro-optical device.

2. Related Art

As display devices for electronic apparatuses such as personal computers or mobile phones, electro-optical devices such as liquid crystal displays are commonly used. The electro-optical devices include circuit boards, for example, a flexible board mounted with electronic components. However, with the development of a downsized and high-performance electro-optical device, the pitch of terminals of electronic components has become more narrow. Specifically, for example, there is a demand for mounting the terminals of the electronic apparatus on a component-placement copper foil land on a board.

In response thereto, for example, a method, in which mounting is carried out by modifying a mount-position coordinates using a plurality of coordinates modification marks, has been proposed. However, the method has a problem in that there is no mark on the board at a central position of the electronic component, which makes it difficult to measure the coordinates correctly by deciding on the central position with the naked eye alone. Further, the mounting requires some time.

To prevent this, there has been proposed employment of a copper foil land portion that faces terminals of a rectangular component in which the terminals are disposed in the four direction of a printed circuit board, a reference hole that is a reference point used to determine a location of an automatic component-placement machine and serves as a coordinates origin when arranging components to be mounted, a center location mark that indicates a center location of the rectangular component and indicates a coordinates point used to place components in the component-placement machine, and a recognition mark that corrects a location error when the rectangular component is disposed on a diagonal line or outside the diagonal line, being spaced apart a equidistance from the center location mark, and corrects a component-placement angle (see JP A-5-206593 from paragraph [0009] to [0012], FIG. 1).

In the aforementioned proposal, a size measurement that is used to correct a manufacturing error prior to placing components to be automatically mounted can be easily taken. However, there has been a problem in that original manufacturing errors, for example, the occurrence of a location deviation between the location of an actually formed terminal and that of a terminal formed by a location-matching mark (hereinafter referred to as an alignment mark) cannot be easily prevented.

### SUMMARY

An advantage of some aspects of the invention that it provides is a mount structure that prevents the occurrence of a location deviation between the location of an actual terminal and that of a terminal formed using an alignment mark, and improves electrical reliability, an electro-optical device using the mount structure, a method of manufacturing the electro-optical device, and an electronic apparatus using the electro-optical device.

According to a first aspect of the invention, there is provided a mount structure including: a board; a conductive layer disposed on the board; a protection layer that is disposed on at least the conductive layer, and has first and second apertures disposed within a region in which the conductive layer is disposed; and an electronic component that is mounted on the board, and has a terminal electrically connected to the conductive layer in a region surrounded by a fringe of the first aperture, wherein a region surrounded by a fringe of the second aperture is an alignment mark that is used to match the location of the terminal of the electronic apparatus to the location of the first aperture.

If not mentioned specifically, the term of an aperture includes not only a conductor in which a protection layer is entirely removed but also a conductor in which a thin protection layer remains. In addition, the term of a conductive layer includes all electricity transmitting mediums such as a metal layer.

The occurrence of a location deviation between the first aperture that forms a terminal on the board and a terminal formed by an alignment mark can be easily prevented so as to improve electrical reliability. This is achieved by including a protection layer that is disposed on the conductive layer and has the first and second apertures disposed within the region in which the conductive layer is disposed, and an electronic component that has a terminal electrically connected to the conductive layer in a region surrounded by the fringe of the first aperture. This is also achieved by allowing a region surrounded by the fringe of the second aperture to form an alignment mark that is used to match the location of the terminal of the electronic apparatus to the location of the first aperture.

The alignment mark may be formed by patterning the conductive layer, and the protection layer is laminated thereon, so that the second aperture is formed to be larger than the alignment mark, with the alignment mark being exposed. A terminal of the electronic component is electrically connected to the conductive layer exposed by the first aperture. Then, if the first and second apertures of the protection layer are laterally deviated to the extent that the alignment mark within the second aperture is not covered, the location of the alignment mark is not modified, but the first aperture that determines the location of the board is deviated.

As a result, the location of the terminal formed by the alignment mark is deviated from the location of the first aperture that forms the actual terminal. There may be a concern over creation of a solder ball in an unnecessary place when connecting a solder, or increase in a contact resistor when a contact area between the terminal of the board and the terminal of the electronic component is reduced.

If the first and second apertures are exposed to light, developed, and formed using one exposure mask at the same time by forming an alignment mark in a region surrounded by a fringe of the second aperture while disposing the first and second apertures on the same protective layer and allowing the terminal of the electronic component to be electrically connected to the conductive layer in a region surrounded by the fringe of the first aperture, then even if the second aperture that is an alignment mark is deviated due to deviation of the exposure mask, the first aperture is also deviated by that extent. Accordingly, the first and third apertures which determine the actual second terminals can maintain a predetermined positional-relation with respect to the terminals formed by the first and second alignment marks. In addition, the occurrence of location deviation between the actual terminal and the terminal formed by the alignment mark can be easily prevented, thereby improving electrical reliability.

According to a second aspect of the invention, there is provided a mount structure including: a board; a conductive layer disposed on the board; a protection layer having a first aperture that is disposed within a region in which the conductive layer is disposed, and a second aperture that is disposed in a different region from where the conductive layer is disposed on the board; and an electronic component that is mounted on the board, and has a terminal electrically connected to the conductive layer in a region surrounded by a fringe of the first aperture, wherein a region surrounded by a fringe of the second aperture is an alignment mark that is used to match the location of the terminal of the electronic apparatus to the location of the first aperture.

Since the protection layer has the first aperture that is disposed within a region in which the conductive layer is disposed, and the second aperture that is disposed in a different region from where the conductive layer is disposed, difference between a material of a base substrate of a flexible board and a material of the protection layer can be recognized, and the second aperture may be used as an alignment mask. Accordingly, the conductive layer can be disposed in a smaller area, thereby further reducing manufacturing cost.

According to a third aspect of the invention, there is provided an electro-optical device including: a board electrically connected to an electro-optical panel; a conductive layer disposed on the board; a protection layer that is disposed on at least the conductive layer, and has first and second apertures disposed within a region in which the conductive layer is disposed; and an electronic component that is mounted on the board, and has a terminal electrically connected to the conductive layer in a region surrounded by a fringe of the first aperture, wherein a region surrounded by a fringe of the second aperture is an alignment mark that is used to match the location of the terminal of the electronic apparatus to the location of the first aperture.

If the first and second apertures are exposed to light, developed, and formed using one exposure mask at the same time by forming an alignment mark in a region surrounded by a fringe of the second aperture while disposing the first and second apertures on the same protective layer and allowing the terminal of the electronic component to be electrically connected to the conductive layer in a region surrounded by the fringe of the first aperture, then even if the second aperture that is an alignment mark is deviated due to deviation of the exposure mask, the first aperture is also deviated by that extent. Accordingly, the first and third apertures which determine the actual second terminals can maintain a predetermined positional-relation with respect to the terminals formed by the first and second alignment marks. In addition, the occurrence of location deviation between an actual terminal and a terminal formed by an alignment mark can be easily prevented, thereby improving electrical reliability.

It is preferable that the second aperture is disposed in a different region from where the first aperture is disposed within a region in which the same conductive layer having the first aperture is disposed. Accordingly, in a region surrounded by the fringe of the second aperture that forms the alignment mark, for example, a copper foil may be exposed, thereby intensifying contrast of reflection light with respect to the surrounding protection layer. In addition, the location of the alignment mark can be correctly recognized by a camera or the like. In addition, by disposing the first and second apertures on the same conductive layer, manufacturing cost can be reduced.

It is preferable that the conductive layer includes first and second conductive layers disposed in different regions, respectively. Here, the first aperture is disposed within a region in which the first conductive layer is disposed, and the second aperture is disposed within a region in which the second conductive layer is disposed. Accordingly, since the first aperture and the second aperture can be separate conductive layers, an electronic component can be mounted on the board in a more flexible manner when designing its disposition, thereby obtaining the effective board.

It is preferable that the conductive layer exposed through the protection layer by the first aperture is coated with an oxidation resistance metal layer. Here, the oxidation resistance metal layer is determined as a metal layer which is hardly oxidized such as gold. Accordingly, the conductive layer exposed from the first aperture electrically connected to the terminal of the electronic component can be restricted, and the electrical resistor between the wire of the conductive layer and the terminal of the electronic component can be restricted, resulting in further improving electrical reliability.

It is preferable that the electro-optical device further includes a second conductive layer that does not overlap the conductive layer. Here, the protection layer is disposed at least on the second conductive layer, and has third and fourth apertures which do not overlap each other within a region in which the second conductive layer is disposed. Further, the electronic component has a second terminal electrically connected to the second conductive layer in a region surrounded by a fringe of the third aperture. Furthermore, along with a region surrounded by a fringe of the second aperture, a region surrounded by a fringe of the fourth aperture is an alignment mark that is used to match the locations of the terminal of the electronic apparatus and the second terminal to the locations of the first and third apertures, respectively. Accordingly, in a region to be the fourth alignment mark, for example, a copper foil may be exposed, thereby intensifying contrast of reflection light with respect to the surrounding protection layer. In addition, the location of the alignment mark can be correctly recognized by a camera or the like. In addition, by disposing the third and fourth apertures on the same conductive layer, manufacturing cost can be reduced.

It is preferable that the electro-optical device further comprises third and fourth conductive layers that overlap neither the conductive layer nor each other. Here, the protection layer is disposed on the third and fourth conductive layers, and has a third aperture disposed within a region in which the third conductive layer is disposed, and a fourth aperture disposed within a region in which the fourth conductive layer is disposed. Further, the electronic component has a second terminal electrically connected to the third conductive layer in a region surrounded by a fringe of the third aperture. Furthermore, along with a region surrounded by the fringe of the second aperture, a region surrounded by the fringe of the fourth aperture is an alignment mark that is used to match the locations of the terminal of the electronic apparatus and the second terminal to the locations of the first and third apertures, respectively. Accordingly, since the third aperture and the fourth aperture can be separate conductive layers, an electronic component can be mounted on the board in a more flexible manner when designing its disposition, thereby obtaining the effective board.

According to a fourth aspect of the invention, there is provided a method of manufacturing an electro-optical device having an electro-optical panel to which a board mounted with an electronic component is electrically connected. The method includes: a formation process in which a conductive layer is formed on the board; a layer-formation process in which a protection layer is formed on the conductive layer formed in the formation process; an aperture-formation process in which first and second apertures are formed in the protection layer within a region of the conductive layer such that the first and second apertures do not overlap each other; a location-matching process in which the location of a terminal of the electronic component electrically connected to the conductive layer in a region surrounded by a fringe of the first aperture is matched to the location of the first aperture by using a first alignment mark formed in a region surrounded by a fringe of the second aperture, and a mounting process in which the electronic component that has undergone the location-matching process is mounted on the board.

Since the invention includes: a layer-formation process in which a protection layer is formed on the conductive layer formed in the formation process; an aperture-formation process in which first and second apertures are formed in the protection layer within a region of the conductive layer such that the first and second apertures do not overlap each other; and a location-matching process in which the location of a terminal of the electronic component electrically connected to the conductive layer in a region surrounded by a fringe of the first aperture is matched to the location of the first aperture by using a first alignment mark formed in a region surrounded by a fringe of the second aperture formed in the aperture-formation process, for example, even if the first and second apertures are deviated in the aperture-formation process, the first alignment mark is formed in a region surrounded by the fringe of the second aperture, and coincides with the deviation of the second aperture.

Accordingly, if a positional-relation between the first and second apertures is maintained, the terminal formed by the first alignment mark is not deviated from the location of the first aperture that forms the second terminal. In addition, for example, creation of a solder ball in an unnecessary place at a time of solder connection can be prevented. In addition, a contact resistance can be prevented from increasing when the contact area between the board terminal and the terminal of the electronic component is reduced. As a result, electrical reliability can be improved.

It is preferable that, in the aperture-formation process, the first aperture and the second aperture are exposed to light at the same time by using an integral exposure mask. Accordingly, even if the second aperture that becomes the first alignment mark is deviated when the exposure mask is deviated, the first aperture is also deviated by that extent. Therefore, the terminal formed by the first alignment mark is not deviated from the location of the first aperture that becomes the location of the actual terminal. In addition, the occurrence of location deviation between the actual terminal and the first alignment mark can be easily prevented, thereby improving electrical reliability.

It is preferable that, in the formation process, a second conductive layer is formed that does not overlap the conductive layer. Here, in the layer-formation process, the protection layer is formed on the second conductive layer formed in the formation process. Further, in the aperture-formation process, third and fourth apertures are formed in the protection layer within a region of the second conductive layer, such that the third and fourth apertures do not overlap each other. Furthermore, in the location-matching process, the location of a second terminal electrically connected to the second conductive layer is matched to the locations of the first and third apertures in a region surrounded by the terminal of the electronic component and a fringe of the third aperture, by using the first alignment mark and a second alignment mark formed in a region surrounded by the fringe of the fourth aperture. Accordingly, in a region surrounded by the fringe of the fourth aperture that forms the second alignment mark, for example, a copper foil may be exposed, thereby intensifying contrast of reflection light with respect to the surrounding protection layer. In addition, the location of the alignment mark can be correctly recognized by a camera or the like. In addition, by disposing the third and fourth apertures on the same conductive layer, manufacturing cost can be reduced.

It is preferable that, in the formation process, third and fourth conductive layers are formed such that the third and fourth conductive layers overlap neither the conductive layer nor each other. Here, in the layer-formation process, the protection layer is formed on the third and fourth conductive layers formed in the formation process. Further, in the aperture-formation process, third and fourth apertures are formed in the protection layer respectively within the region in which the third conductive layer is formed and within the region in which the fourth conductive layer is formed. Furthermore, in the location-matching process, the location of the second terminal electrically connected to the third conductive layer in a region surrounded by the terminal of the electronic component and the fringe of the third aperture is matched to the locations of the first and third apertures by respectively using the first alignment mark and a second alignment mark formed in a region surrounded by the fringe of the fourth aperture. Accordingly, since the third aperture and the fourth aperture can be separate conductive layers, an electronic component can be mounted on the board in a more flexible manner when designing its disposition, thereby obtaining the effective board.

According to a fifth aspect of the invention, there is provided an electronic apparatus having the aforementioned electro-optically device.

Accordingly, since location deviation between the actual terminal and the terminal formed by the alignment mark can be easily prevented, and the electro-optical device can improve electrical reliability, product reliability can be further improved, and downsized high-performance electronic apparatus can be provided.

### BRIEF DESCRIPTION OF THE DRAWINGS

The invention will be described with reference to the accompanying drawings, wherein like numbers reference like elements.

FIG. 1 is a schematic perspective view of a liquid crystal device according to a first embodiment of the invention.

FIG. 2 is a schematic cross-sectional view of FIG. 1, viewed along the Line A-A (an X-driver is not cut).

FIG. 3 is a schematic plan view of an alignment mark or the like according to the first embodiment of the invention.

FIG. 4 is a schematic cross-sectional view of FIG. 3, viewed along the Line B-B (an electronic component is not cut).

FIG. 5 is a flowchart of a method of manufacturing a liquid crystal device according to the first embodiment of the invention.

FIG. 6 shows formation of an aperture and an oxidation resistance metal layer according to the first embodiment of the invention.

FIG. 7 shows a solder print and a resistor mount according to the first embodiment of the invention.

FIG. 8 shows an electronic component matched to a predetermined location according to the first embodiment of the invention.

FIG. 9 shows deviation of an aperture according to the first embodiment of the invention.

FIG. 10 shows an exposed plating wire when an aperture is deviated.

FIG. 11 is a schematic plan view of an alignment mark or the like according to a second embodiment of the invention.

FIG. 12 is a schematic plan view of an alignment mark or the like according to a third embodiment of the invention.

FIG. 13 is a schematic plan view of an alignment mark or the like according to a fourth embodiment of the invention.

FIG. 14 is a schematic block diagram of a display control system of an electronic apparatus according to a fifth embodiment of the invention.

### DESCRIPTION OF EXEMPLARY EMBODIMENTS

Hereinafter, exemplary embodiments of the invention will be described with reference to the accompanying drawings. Although a TFT (Thin Film Transistor) active matrix type liquid crystal device, or an electronic apparatus using the liquid crystal device will be described as an example of a mount structure and an electro-optical device in the following embodiments, the invention is not limited thereto. In addition, for clear understanding, a reduced-scale may be used or the number of elements in the accompanying drawings may be different from that of the actual substantial structure.

### First Embodiment

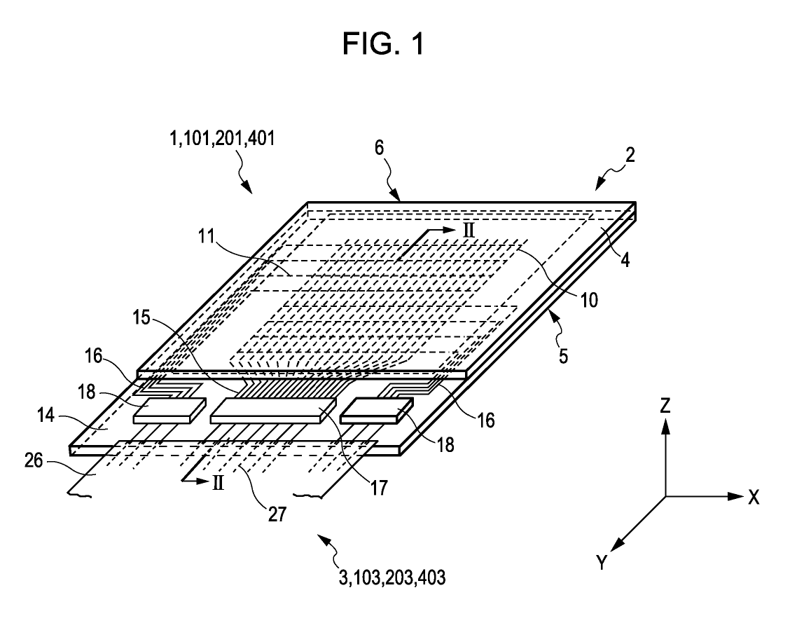

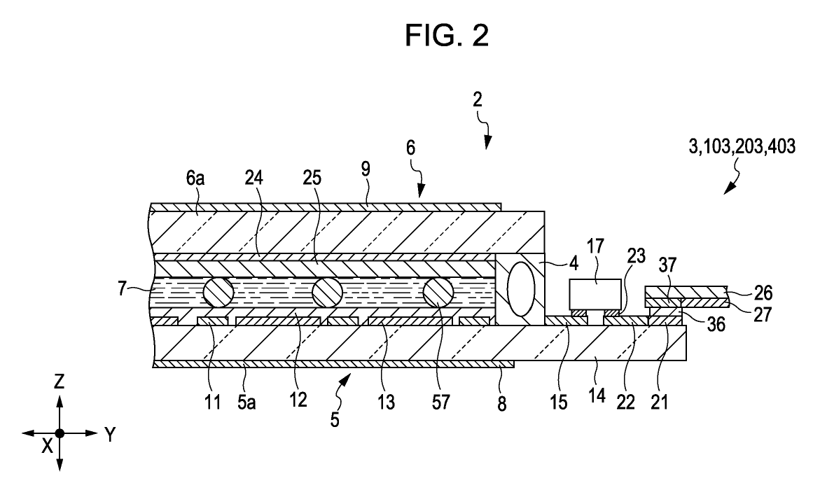

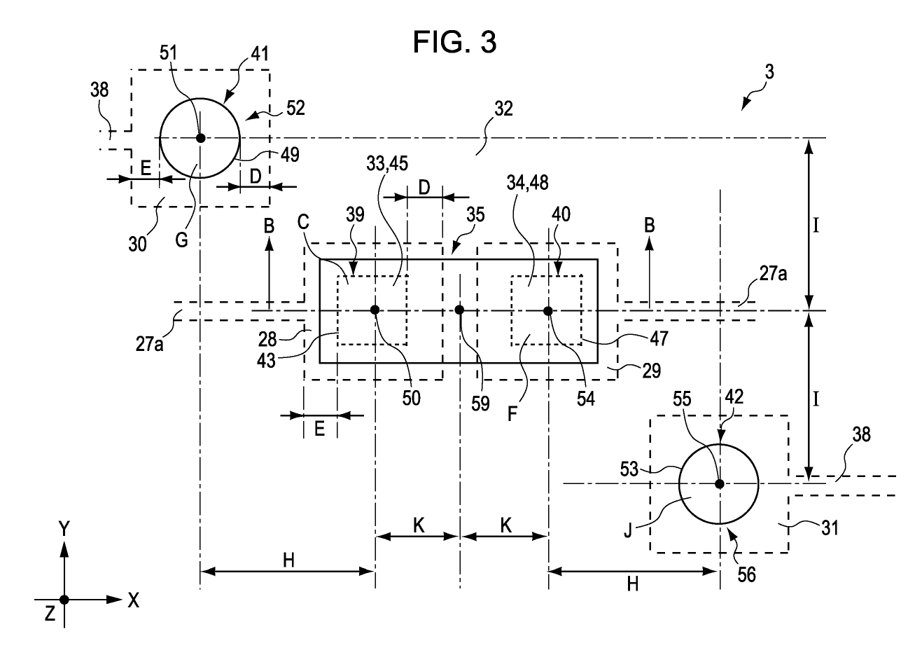

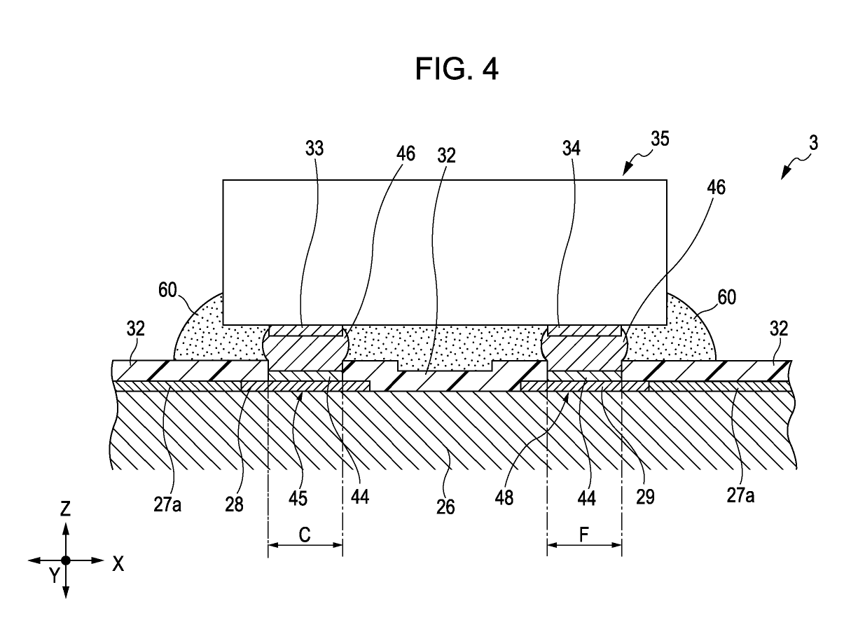

FIG. 1 is a schematic perspective view of a liquid crystal device according to a first embodiment of the invention. FIG. 2 is a schematic cross-sectional view of FIG. 1, viewed along the Line A-A (an X-driver is not cut). FIG. 3 is a schematic plan view of an electronic component mounted on a flexible board and alignment marks. FIG. 4 is a schematic cross-sectional view of FIG. 3, viewed along the Line B-B (an electronic component is not cut).

Structure of Liquid Crystal Device

A liquid crystal device 1, as shown, for example, in FIG. 1, includes a liquid crystal panel 2 as an electro-optical panel, and a flexible board 3 as a mount structure connected to the liquid crystal panel 2. Besides the flexible board 3, the liquid crystal device 1 may be optionally provided with an illumination device (not shown) such as a backlight, or additional mechanisms.

As shown, for example, in FIGS. 1 and 2, the liquid crystal panel 2 includes a first board 5 and a second board 6 that are in contact with each other via a seal material 4, and a TN (Twisted Nematic)-type liquid crystal 7 that is sealed in a gap between the two boards.

The first and second boards 5 and 6 respectively include first and second substrates 5a and 6a that are formed of a transparent plate-shaped member (e.g. glass). As shown, for example, in FIG. 2, polarizing plates 8 and 9 are respectively attached to the outer surfaces of the first and second substrates 5a and 5b so as to polarize incident light.

As shown, for example, in FIGS. 1 and 2, the inner surface (liquid crystal side) of the first substrate 5a may be provided with a gate electrode 10 disposed in a Y-axis direction and a source electrode 11 disposed in an X-axis direction as a signal line. In addition, an alignment film 12 is formed on the liquid crystal side of the gate electrode 10 and the source electrode 11. The gate electrode 10 and the source electrode 11 are formed of nickel or the like, and are electrically connected to a TFT (not shown). The TFT is electrically connected to a pixel electrode 13 formed of ITO (indium tin oxide).

Accordingly, in the gate electrode 10 and the source electrode 11, current flows from the source electrode 11 to the gate electrode 10, or in a reverse direction thereof, when voltage is applied to the gate electrode 10. In this case, the source electrode 11 supplies a data signal to the pixel electrode 13, and the pixel electrode 13 applies a corresponding voltage to the liquid crystal 7 interposed therebetween as a common electrode to be described below.

As shown, for example, in FIGS. 1 and 2, the first substrate 5a includes a protrusion 14 protruding with respect to an outer end of the second substrate 6a. The protrusion 14 is formed with a gate electrode wire 15 and a source electrode wire 16 that extend towards the protrusion 14 from a region in which the gate electrode 10 and the source electrode 11 are surrounded by the seal material 4. Further, an X-driver 17 and a Y-driver 18 are mounted on the first substrate 5a, and are electrically connected to each electrode wire so as to drive the liquid crystal.

As shown, for example, in FIGS. 1 and 2, the protrusion 14 includes an electrode terminal (not shown) that is electrically connected to the gate electrode wire 15 and the source electrode wire 16 within a region corresponding to a mount surface of the X-driver 17 and the Y-driver 18, and an input terminal (not shown) through which current is input to the X-driver 17 and the Y-driver 18 from the flexible board 3.

As shown, for example, in FIG. 2, the protrusion 14 includes an external terminal 21 that receives current from the flexible board 3, and an input wire 22 that supplies an external current to the input terminal.

As shown, for example, in FIG. 2, the X-driver 17 and the Y-driver 18 include a plurality of bumps 23 electrically connected to the electrode terminal and the input terminal that are mounted on the protrusion 14. The electrical connection may be made by using an ACF (anisotropic conductive film) (not shown) serving as an adhesive material between the electrode terminal (or the input terminals) and the bump 23.

On the other hand, the second substrate 6a is formed with a common electrode 24 on the inner surface (liquid crystal side) thereof. The liquid crystal side of the common electrode 24 is formed with an alignment film 25.

Although not shown, the liquid crystal side of the first and second substrates 5a and 6a is optionally formed with a substrate layer, a reflection layer, a coloring layer, a light-shielding layer, and so on.

As shown, for example, in FIGS. 1 to 3, the flexible board 3 includes a wire pattern 27 composed of two different conductive layers that are formed of copper (Cu) or the like formed on a base substrate 26 serving as a board.

Further, the flexible board 3 includes a first conductor 28 as a first conductive layer electrically connected to the wire pattern 27, a third conductor 29 as a third conductive layer, a second conductor 30 as a second conductive layer, and a fourth conductor 31 as a fourth conductive layer. Furthermore, the flexible board 3 includes a protection layer 32 laminated on the above conductors. Furthermore, the flexible board 3 is mounted with a resistor 35, or the like, that is an electric component having first terminals 33 and 34 as two different terminals respectively electrically connected to the first conductor 28 and the third conductor 29.

As shown, for example, in FIGS. 1 and 3, the wire pattern 27 includes an output terminal 37 that is electrically connected to the external terminal 21 of the first board 5 via an anisotropic conductive film 36. Further, the wire pattern 27 includes a wire 27a electrically connected to the first conductor 28 and the third conductor 29, and a plating wire 38 that electroplates the second conductor 30 and the fourth conductor 31.

The first conductor 28 and the third conductor 29 are substantially rectangular in shape and are separated in parallel with each other on the base substrate 26, as shown, for example, in FIG. 3. The wire 27a is electrically connected to the first conductor 28 and the third conductor 29.

As shown, for example, in FIG. 3, the second conductor 30 and the fourth conductor 31 are formed in a rectangular shape in the upper-left side and the lower-right side of FIG. 3, respectively, so that the first conductor 28 and the third conductor 29 are inserted. The plating wire 38 is electrically connected to the second conductor 30 and the fourth conductor 31.

The conductors 28, 29, 30, and 31 are formed of copper (Cu) or the like. The number of first and third conductors is not limited to two. For example, if an electric component is not the resistor, and has two or more terminals, the number of first and third conductors formed may be the same as the number of terminals.

In the protection layer 32, as shown, for example, in FIGS. 3 and 4, a photoconductive resin or the like is laminated on the wire 27a and the conductors 28, 29, 30, and 31. Further, first to fourth apertures 39, 40, 41, and 42 are formed so as to expose each of the first to fourth conductors.

The first aperture 39, as shown, for example, in FIG. 3, is entirely included inside a region (surrounded by a larger dotted line shown in the left side of FIG. 3) of the first conductor 28, and a region C (surrounded by a smaller dotted line shown in FIG. 3) surrounded by a fringe 43 of the first aperture 39.

Accordingly, as shown, for example, in FIG. 3, when a distance between a right vertical fringe of the first aperture 39 and a right vertical fringe of the first conductor 28 is determined as a gap D (a length in the X-axis direction of FIG. 3), and in the same manner, a left gap therebetween is determined as a gap E (a length in the X-axis direction of FIG. 3), if horizontal deviation occurs within the range of the gaps D and E, the first conductor 28 is exposed from the protection layer 32 over the entire region C of the first aperture 39. This is also applied in the Y-axis direction of the first aperture, as shown, for example, in FIG. 3. As a result, when deviation occurs within a region of the first conductor 28, the first conductor 28 is exposed from the protection layer 32 over the entire region C of the first aperture 39.

The first conductor 28 exposed from the protection layer 32, as shown, for example, in FIG. 4, is plated with an oxidation resistance metal layer 44 such as gold (Au), and is electrically connected to the first terminal 33 as a terminal via the oxidation resistance metal layer 44.

The first conductor 28 exposed from the protection layer 32, and the oxidation resistance metal layer 44 become a second terminal 45 formed in the region C surrounded by the fringe 43 of the first aperture 39. The second terminal 45, as shown, for example, in FIG. 4, allows the first terminal 33 of the resistor 35 to be electrically connected to the first conductor 28 via a solder portion 46.

Likewise, the third aperture 40, as shown, for example, in FIG. 3, is entirely included inside a region (surrounded by a larger dotted line shown in the right side in FIG. 3) of the third conductor 29, in a region F (surrounded by a smaller dotted line of FIG. 3) surrounded by a fringe 47 of the third aperture 40.

Accordingly, if deviation occurs within the region of the third conductor 29, the third conductor 29 is exposed from the protection layer 32 over the entire region F of the third aperture 40.

The surface of the exposed third conductor 29, as shown, for example, in FIG. 4, is plated with the oxidation resistance metal (Au) layer 44, and is electrically connected to the first terminal 34 as another terminal via the oxidation resistance metal layer 44.

The third conductor 29 exposed from the protection layer 32, and the oxidation resistance metal layer 44 become a second terminal 48 formed in the region F surrounded by the fringe 47 of the third aperture 40. The second terminal 48 allows the first terminal 34 of the resistor 35 to be electrically connected to the third conductor 29 via the solder portion 46.

The second aperture 41, as shown, for example, in FIG. 3, is formed in a circular shape inside a region (surrounded by a dotted line in the left side of FIG. 3) of the second conductor 30, so as to be entirely included in a region G (surrounded by a solid line of FIG. 3) surrounded by a fringe 49 of the second aperture 41. The second aperture 41 is not limited to the circular shape, and may have a rectangular shape, a star shape, or a polygon shape.

The second aperture 41 is formed such that the second conductor 30 is exposed over the entire region G surrounded by the fringe 49 thereof.

In the second aperture 41, as shown, for example, in FIG. 3, a right end of the fringe 49 of the second aperture 41 is spaced apart by a gap D (a length in the X-axis direction of FIG. 3) from a right vertical fringe of the second conductor 30, and in the same manner, a gap E (a length in the X-axis direction of FIG. 3) is formed at the left side thereof.

Accordingly, if horizontal deviation occurs within the gaps D and E, the second conductor 30 is exposed over the entire region G of the second aperture 41. This is also applied in the Y-axis direction of the second aperture 41, as shown, for example, in FIG. 3. As a result, when deviation occurs within the region of the second conductor 30, the second conductor 30 is exposed from the protection layer 32 over the entire region G of the second aperture 41.

The gaps D and E between the second aperture 41 and the second conductor 30 are the same as the gaps D and E between the first aperture 39 and the first conductor 28, and deviation distances (possible deviation distances) become the same, where a deviation distance is determined as a maximum distance that is derived when the second aperture 41 and the first aperture 39 are deviated from the conductors after the conductors are respectively exposed from the entire regions of the second aperture 41 and the first aperture 39. The gap from the second aperture 41 or the first aperture 39 is not limited to the gap D or the gap E, and a variety of gaps may be applied. In this case, however, the smallest gap becomes the possible deviation distance of a corresponding direction.

The second aperture 41 is positionally related to the first aperture 39. As shown, for example, in FIG. 3, an aperture center 51 of the second aperture 41 is positioned to the left by H with respect to an aperture center 50 of the first aperture 39 in a widthwise direction (the X-axis direction of FIG. 3), and is positioned upwards by I in a lengthwise direction thereof (the Y-axis direction of FIG. 3).

The surface of the second conductor 30 in a region G surrounded by the fringe 49 of the exposed second aperture 41 is plated with the oxidation resistance metal layer 44 such as gold (Au), such that its light reflection rate is different from that of the protection layer 32 around the region G. Accordingly, a shape formed in the region G can be clearly recognized as a mark. For example, the mark may be a first alignment mark 52 that is used to match the location of the first terminal 33 to the location of the second terminal 45, that is, the first aperture 39. In the second aperture 41, the first alignment mark 52 is formed in the region G surrounded by the fringe 49 of the second aperture 41.

The first alignment mark 52 is not limited to the above description in which the first alignment mark 52 is formed by utilizing disparity in a light reflection rate with respect to the protection layer 32 around the oxidation resistance metal layer 44. For example, instead of coating the oxidation resistance metal layer 44, the first alignment mark 52 may be formed by utilizing disparity in the light reflection rate with respect to the protection layer 32 around the second conductor 30, with the second conductor 30 being exposed. Accordingly, the oxidation resistance metal layer 44 can be formed without having to use gold or the like as the second conductor 30, thereby reducing manufacturing cost.

Like the second aperture 41, as shown, for example, in FIG. 3, the fourth aperture 42 is formed in a circular shape inside a region (surrounded by a dotted line in the right side of FIG. 3) of the fourth conductor 31, so as to be entirely included in a region J (surrounded by a solid line of FIG. 3) surrounded by a fringe 53 of the fourth aperture 42.

Accordingly, when deviation occurs within the region of the fourth conductor 31, the fourth conductor 31 is exposed from the protection layer 32 over the entire region J of the fourth aperture 42.

The fourth aperture 42 is positionally related to the third aperture 40. As shown, for example, in FIG. 3, an aperture center 55 of the fourth aperture 42 is positioned to the right by H with respect to an aperture center 54 of the third aperture 40 in a widthwise direction (the X-axis direction of FIG. 3), and is positioned downwards by I in a lengthwise direction thereof (the Y-axis direction of FIG. 3).

The surface of the fourth conductor 31 in a region J surrounded by the fringe 53 of the exposed fourth aperture 42 is plated with the oxidation resistance metal layer 44 such as gold (Au), such that its light reflection rate is different from that of the protection layer 32 around the region J. Accordingly, a shape formed in the region J can be clearly recognized as a mark. For example, the mark may be a second alignment mark 56 that is used to match the location of the first terminal 34 to the location of the second terminal 48, that is, the third aperture 40. In the fourth aperture 42, the second alignment mark 56 is formed in the region J surrounded by the fringe 53 of the fourth aperture 42.

Like the first alignment mark 56 of FIG. 1, the second alignment mark 56 is not limited to the above description in which the second alignment mark 56 is formed by utilizing disparity in the light reflection rate with respect to the protection layer 32 around the oxidation resistance metal layer 44. For example, instead of coating the oxidation resistance metal layer 44, the second alignment mark 56 may be formed by utilizing disparity in the light reflection rate with respect to the protection layer 32 around the fourth conductor 31, with the fourth conductor 31 being exposed.

In the above description, as shown, for example, in FIG. 3, it has been described that the wire 27a or the plating wire 38 are electrically connected to the first to fourth conductors 28, 29, 30, and 31, and have a size smaller than the widths (distances in the Y-axis direction of FIG. 3) of the first to fourth conductors 28, 29, 30, and 31. However, the invention is not limited thereto, and the wire 27a or the plating wire 38 may have a size equal to the widths of the first to fourth conductors 28, 29, 30, and 31. For example, one end of the wire 27a or the plating wire 38 may extend so as to form the first to fourth conductors 28, 29, 30, and 31.

The resistor 35, an electronic component, as shown, for example, in FIG. 4, has two first terminals 33 and 34 on the mount surface. The first terminals 33 and 34 are respectively electrically connected to the second terminals 45 and 48 formed of the first and third apertures 39 and 40 via the solder portion 46.

Manufacturing Method of Liquid Crystal Device

Now, a manufacturing method of a liquid crystal device having the above structure will be described by focusing on manufacturing of a flexible board.

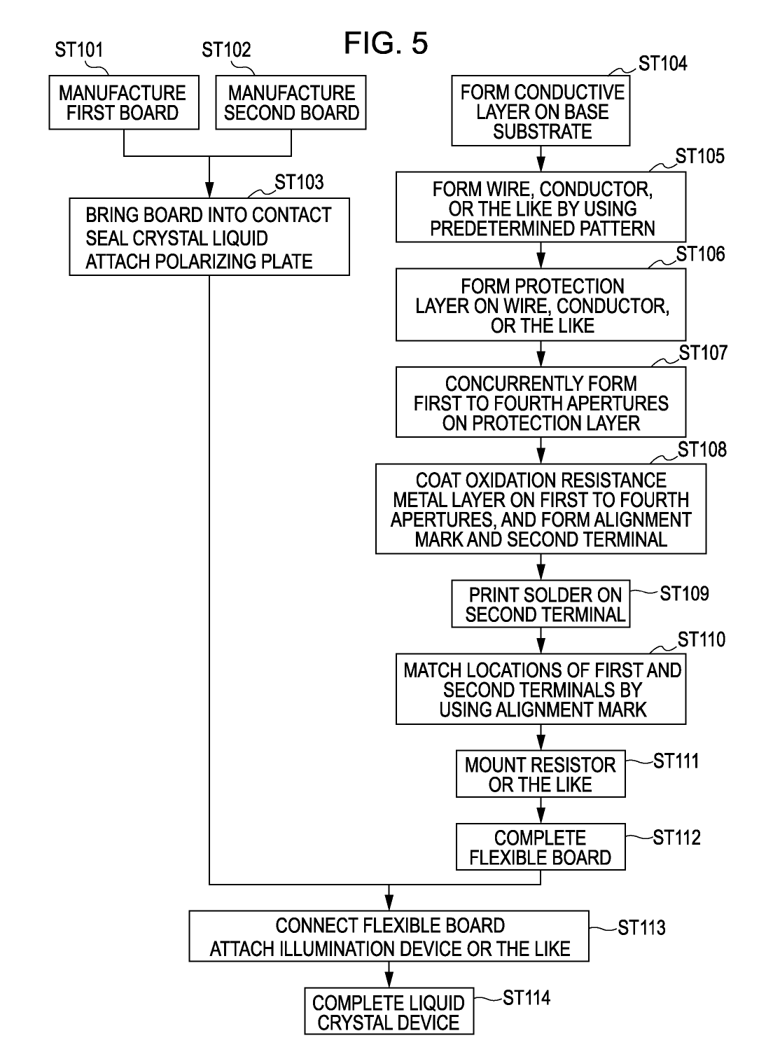

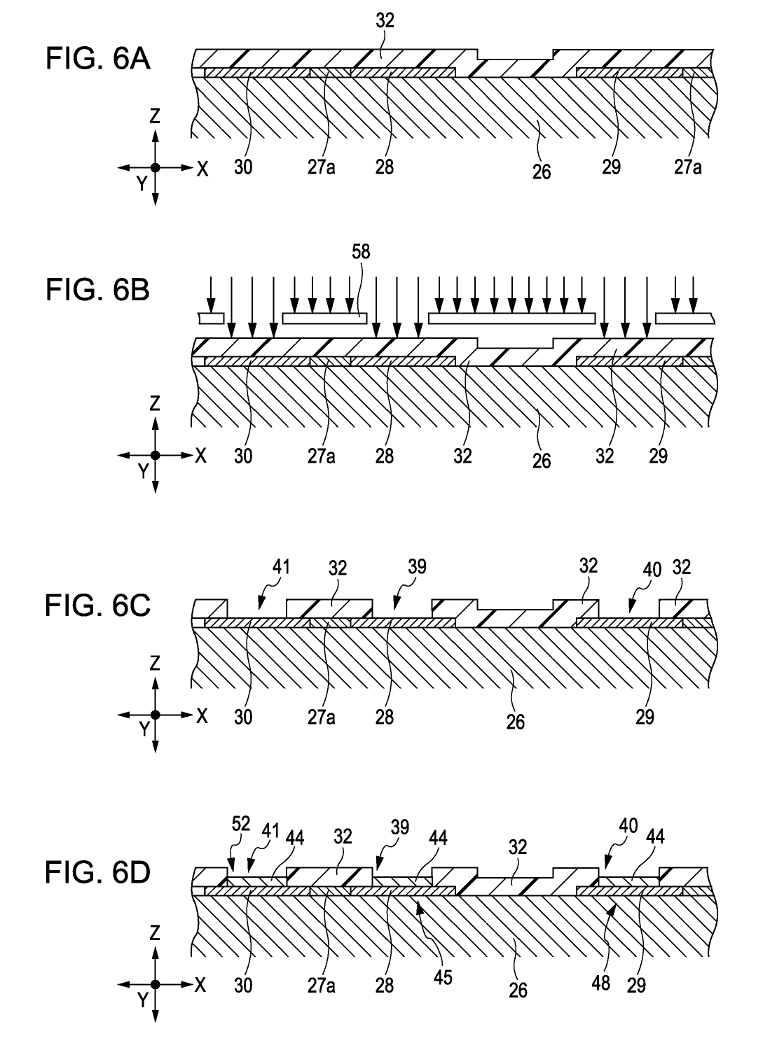

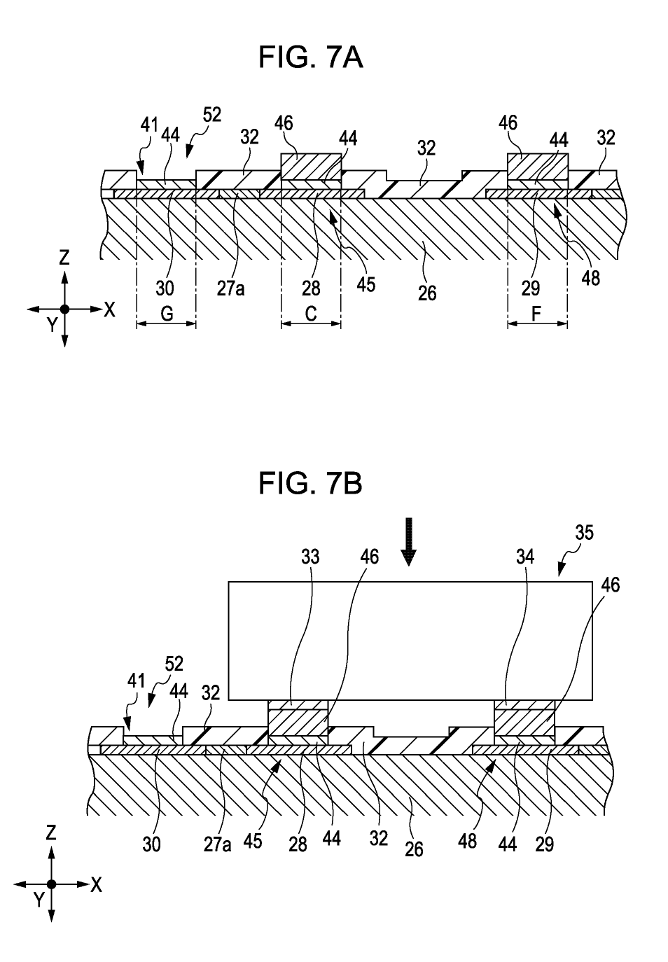

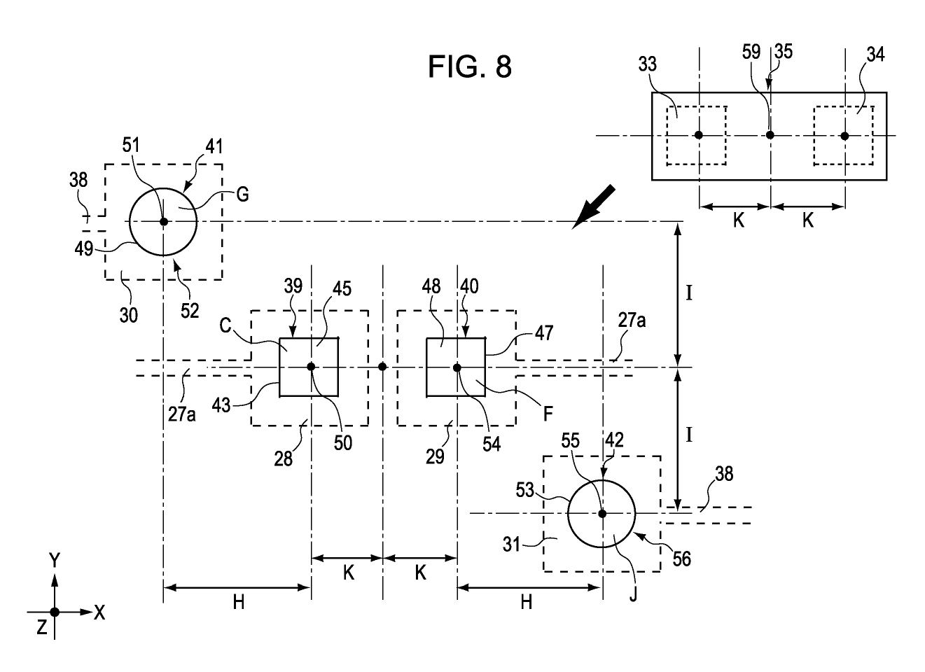

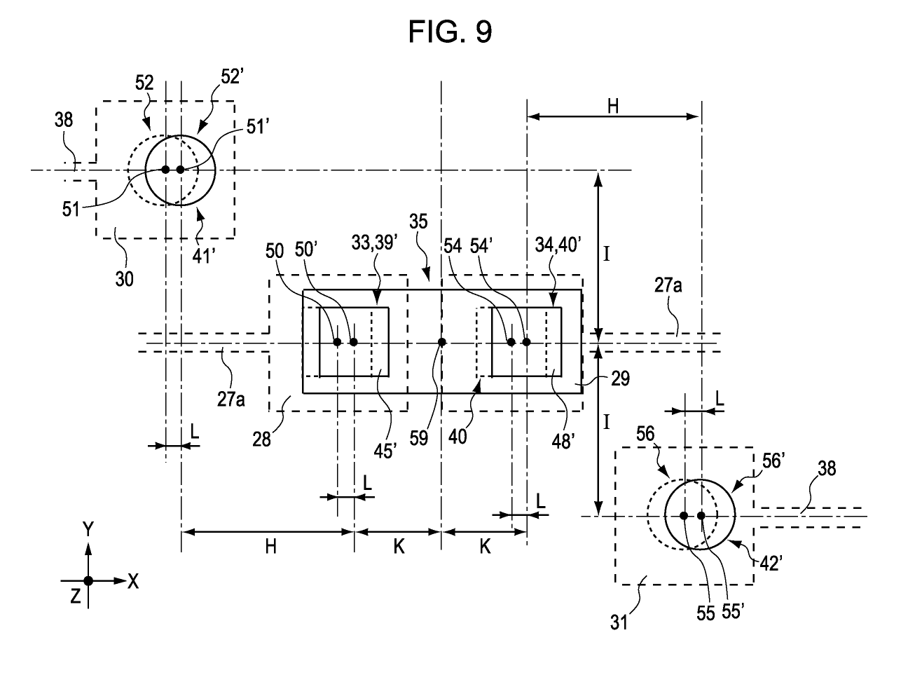

FIG. 5 is a flowchart of a method of manufacturing a liquid crystal device. FIG. 6 shows formation of an aperture and an oxidation resistance metal layer. FIG. 7 shows a solder print and a resistor mount. FIG. 8 shows an electronic component matched to a predetermined location. FIG. 9 shows deviation of an aperture. For convenience, FIGS. 6 and 7 are shown in a cross-sectional view so that the second aperture 41 can be also shown along with the first apertures 39 and 40. In practice, for example, if cut along the Line B-B direction, the second aperture cannot be shown since it is covered by the wire 27a or the protection layer 32.

First, a manufacturing process of the liquid panel 2 will be described in brief.

As shown, for example, in FIGS. 1, 2, and 5, the TFT, the gate electrode 10, the source electrode 11, the pixel electrode, and so on are formed on the first substrate 5a (liquid crystal side) by using a sputtering method or a spin coating method, and are then etched by using a photolithography method or the like. Thereafter, the alignment film 12 is formed thereon, and a rubbing process is carried out, thereby completing manufacturing of the first board (ST101).

While a substrate layer, a reflection layer, a coloring layer, and an over-coating layer are optionally formed on the second substrate 6a (liquid crystal side), as shown, for example, in FIGS. 1 and 2, an ITO is formed thereon (liquid crystal side) by using the sputtering method. Thereafter, patterning is carried out by using the photolithography method so as to form the common electrode 24. Then, the alignment film 25 is formed on the common electrode 24 (liquid crystal side), and is subject to a scrubbing process, thereby completing manufacturing of the second substrate (ST102).

Next, a gap material 57 may be sprayed onto the alignment film 25 of the second board 6 by using a dry spraying method or the like. The first board 5 and the second board 6 are brought into contact with each other via the seal material 4. The liquid crystal 7 is inserted though an inserting hole (not shown) of the seal material 4. The inserting hole is sealed by using the seal material such as a UV curable resin, thereby tightly sealing the liquid crystal 7.

The X-driver 17 and the Y-driver 18 are mounted on the protrusion 14 of the first substrate 5a, as shown, for example, in FIGS. 1 and 2, such that the bumps 23 of the X-driver 17 and the Y-driver 18 are electrically connected to electrode terminals via the ACF, and the polarizing plates 8 and 9 are respectively attached to the outer surfaces of both the board-shaped members (ST103).

As a result, the manufacturing of the liquid crystal is completed.

Thereafter, the flexible board 2 is manufactured in a different manner from the above manufacturing process of the liquid panel 2. Hereinafter, the manufacturing process of the flexible board 3 will be described.

First, a conductive layer formed of copper (Cu) or the like is formed on the flexible film-shaped base substrate 26 by using a sputtering method or the like (ST104).

The conductive layer is formed on each of the first to fourth conductors 28, 29, 30, and 31 in a substantially rectangular shape, as shown, for example, in FIG. 3, by using the photolithography method or the like (ST105). When the wire pattern 27 (e.g. the wire 27a, the plating wire 38, etc) is formed of the same material as the conductors, the wire pattern 27 is formed at the same time. Accordingly, the number of manufacturing processes can be decreased, resulting in cost reduction.

Next, as a formation process, a protection layer that is, for example, a positive type photosensitive resin, is formed on the first to fourth conductors 28, 29, 30, and 31, the wire 27a, and the plating wire 38 which are formed by using a predetermined pattern, as shown, for example, in FIG. 6A (ST106).

At the same time, the formed protection layer, as shown, for example, in FIG. 6B, is exposed to light via an integrally formed exposure mask 58 that has open apertures corresponding to regions where the first to fourth apertures 39, 40, 41, and 42 are formed.

Thereafter, the exposed protection layer is developed, as shown, for example, in FIG. 6C, so that the first to fourth apertures 39, 40, 41, and 42 are formed in such a way that the conductors below the protection layer 32 can be entirely exposed (ST107).

Next, as a coating process, each of the surfaces of the first to fourth conductors 28, 29, 30, and 31 exposed from the first to fourth apertures 39, 40, 41, and 42 is coated with the oxidation resistance metal layer 44 formed of gold (Au) or the like, for example, by an electrolytic coating method. In this case, in order to apply voltage, the electrically connected wire 27a may be used for the first and third conductors 28 and 29. Further, the plating wire 38 may be used for the second and fourth conductors 30 and 31. The plating is not limited to the electrolytic coating method, and a non-electrolytic coating method may be used. In this case, the plating wire 38 is not necessary. The formation of the oxidation resistance metal layer 44 is not limited to the plating method, and may be carried out by using an ink-jet method.

By means of the formation of the first to fourth apertures 39, 40, 41, and 42 and the coating of the oxidation resistance metal layer 44, as shown, for example, in FIG. 6D, the second terminals 45 and 48 are formed via the first and third apertures 39 and 40, and the first and second alignment marks 52 and 56 are formed via the second and fourth apertures 41 and 42 (ST108).

Instead of coating the oxidation resistance metal layer 44 in ST108, if the second and fourth conductors 31 and 32 are exposed to form the first and second alignment marks 52 and 56, the second and fourth apertures 41 and 42 may be subject to a masking process, so as not to be plated. The second and fourth conductors 31 and 32 may be exposed with any one of them being subject to the masking process.

Next, as shown, for example, in FIG. 7A, solder is printed on the surface of the oxidation resistance metal layer 44 exposed from the first and third apertures 39 and 40 that form the second terminals by a screen printing method or the like, thereby forming the solder portion 46 (ST109).

Next, as a location-matching process, the locations of the first terminals 33 and 34 of the resistor 35 are matched to the locations of the first and third apertures 39 and 40 of the second terminals 45 and 48 in the same plane by using the first and second alignment marks 52 and 56 (ST110).

Specifically, as shown, for example, in FIG. 8, after reference coordinates of the X and Y axes are predetermined, reference positions of the aperture centers 51 and 55 of the second and fourth apertures 41 and 42 that become the centers of the first and second alignment marks 52 and 56, respectively, are recognized from the reference coordinates by a camera (not shown) or the like. For example, if the center of the first alignment mark 52 is the aperture center 51 of the second aperture 41, and its coordinates are (X1, Y1), then in the same manner, the coordinates of the center of the second alignment mark 56 is (X2, Y2). As a result, the coordinates of the center of a line segment that connects each of the centers of the first and second alignment marks 52 and 56 are determined to be ((X1+X2)/2, (Y1+Y2)/2).

Next, as shown, for example, in FIG. 8, a direction of a line that connects the first terminals 33 and 34 of the resistor 35 as an electronic component to be mounted is parallelized to the X-axis. Further, a reference point 59 of the resistor 35 is located at the center of a suction hole of a robot arm (not shown) so as to be sucked by the robot arm. For example, in FIG. 8, the reference point 59 is the center of the two terminals, and each distance between the centers of the first terminals and the reference point 59 is determined to be K.

Then, the robot arm sucking the resistor 35 as an electronic component moves such that the center of the suction hole can be correctly located at the coordinates ((X1+X2)/2, (Y1+Y2)/2) of the reference coordinate axes. Accordingly, as shown, for example, in FIG. 3, the coordinates of the reference coordinate axes of the aperture center 50 of the first aperture 39 that become the center of the second terminal 45 can be determined to be (X1+H, Y1−I) from the relation between the aperture center 50 and the aperture center 51.

Meanwhile, the coordinates of the reference coordinate axes of the first terminal 33 of the resistor 35 to be matched to the above location become (((X1+X2)/2)−K, (Y1+Y2)/2), since the coordinates of the reference point 59 that is the center between the first terminals of the resistor 35 are ((X1+X2)/2, (Y1+Y2)/2), and a distance between the reference point 59 and the center of the first terminal 33 is K. Here, since X2=X1+2H+2K, and Y2=Y1−2I, the coordinates of the reference coordinate axes of the first terminal 33 become (X1+H, Y1−I).

Accordingly, the coordinates of the reference coordinate axes of the aperture center 50 of the first aperture 39 that become the center of the second terminal 45 coincide with the coordinates of the reference coordinate axes of the center of the first terminal 33.

Likewise, the coordinates of the reference coordinate axes of the aperture center 54 of the third aperture 40 that become the center of the second terminal 48 coincide with the coordinates of the reference coordinate axes of the center of the first terminal 34.

As a result, by using the first and second alignment marks 52 and 56, the locations of the first terminals 33 and 34 of the resistor 35 can be entirely matched in the same plane to the locations of the second terminals 45 and 48, that is, the locations of the first and third apertures 39 and 40, thereby completing the location-matching process.

In this case, for example, when the first to fourth apertures are formed in the protection layer 32, if the exposure mask 58 is deviated by L to the right in the X-axis direction, the first to fourth apertures are deviated to that extent.

Specifically, as shown, for example, in FIG. 9, an aperture center of a deviated second aperture 41′ is deviated by L to the right in the X-axis direction, thereby becoming an aperture center 51′.

Accordingly, a center of an alignment mark of a first alignment mark 52′ formed by a fringe of the deviated second aperture 41′ is also deviated by L to the right in the X-axis direction, thereby becoming the aperture center 51′. Viewed from the aforementioned reference coordinate axes, the coordinates of the first alignment mark 52′ become (X1+L, Y1).

Likewise, a center of a deviated alignment mark 56′ is also deviated by L to the right in the X-axis direction, thereby becoming an aperture center 55′. Viewed from the aforementioned reference coordinate axes, the coordinates of the second alignment mark 56′ become (X2+L, Y2).

In this case, since the first aperture is formed by the same light-exposure process using the same exposure mask 58, deviation also occurs in the first aperture. An aperture center of a deviated first aperture 39′ is deviated by L to the right in the X-axis direction, thereby becoming an aperture center 50′. The second terminal 45 formed by the deviated first aperture 39′ is also deviated by L to the right in the X-axis direction, thereby becoming a second terminal 45′. Viewed from the aforementioned reference coordinate axes, the coordinates of the second alignment mark 45′ become (X1+H+L, Y1−I).

An aperture center of a third aperture 40′ deviated in the same manner as above is deviated by L to the right in the X-axis direction, thereby becoming an aperture center 54′. The second terminal 48 formed by the deviated third aperture 40′ is also deviated to the right in the X-axis direction, thereby becoming a second terminal 48′. Viewed from the aforementioned reference coordinate axes, the coordinates of the second alignment mark 48′ become (X2−H+L, Y2+I).

The locations of the first aperture and the second aperture maintain the same relation with each other after being deviated. For example, the second terminal 45′ is positioned to the right by H in the X-axis direction with respect to the first alignment mark 52′, and is positioned downwards by I in the Y-axis direction.

In this state, the locations of the first terminals 33 and 34 are matched to the locations of the deviated second terminals 45′ and 48′, that is, the deviated first and third apertures, by using the deviated first and second alignment marks 52′ and 56′ in the following ways.

Specifically, as shown, for example, in FIG. 9, after reference coordinates of the X and Y axes are predetermined, reference coordinates of the apertures 51′ and 55′ of the second and the fourth apertures 41′ and 42′ that become the centers of the deviated first and second alignment marks 52′ and 56′, respectively, are recognized from the reference coordinates by a camera (not shown) or the like. For example, if the center of the first alignment mark 52′ is the aperture center 51′ of the second aperture 41′, and its coordinates are (X1+L, Y1), then in the same manner, the coordinates of the center of the second alignment mark 56′ are (X2+L, Y2). As a result, the coordinates of the center of a line segment that connects each of the centers of the first and second alignment marks 52′ and 56′ are determined to be ((X1+X2+2L)/2, (Y1+Y2)/2).

Next, a direction of a line that connects the first terminals 33 and 34 of the resistor 35 as an electronic component to be mounted is parallelized to the X-axis. Further, the reference point 59 of the resistor 35 may be located at the center of a suction hole of a robot arm (not shown) so as to be sucked by the robot arm. For example, in FIG. 9, the reference point 59 is the center of the two terminals, and each distance between the centers of the first terminals and the reference point 59 is determined to be K.

Then, the robot arm sucking the resistor 35 as an electronic component moves such that the center of the suction hole can be correctly located at the coordinates ((X1+X2+2L)/2, (Y1+Y2)/2) of the reference coordinate axes. Accordingly, as shown, for example, in FIG. 9, the coordinates of the reference coordinate axes of the aperture center 50′ of the first aperture 39′ that is the center of the second terminal 45′ can be determined to be (X1+H+L, Y1−I) from the relation between the aperture center 50′ and the aperture center 51′.

Meanwhile, the coordinates of the reference coordinate axes of the first terminal 33 of the resistor 35 to be matched to the above location become (((X1+X2)/2)+L−K, (Y1+Y2)/2), since the coordinates of the reference point 59 that is the center between the first terminals of the resistor 35 are ((X1+X2+2L)/2, (Y1+Y2)/2), and a distance between the reference point 59 and the center of the first terminal 33 is K. Here, since X2=X1+2H+2K, and Y2=Y1−2I, the coordinates of the reference coordinate axes of the first terminal 33 become (X1+H+L, Y1−I).

Accordingly, the coordinates of the reference coordinate axes of the aperture center 50′ of the first aperture 39′ that are the center of the second terminal 45′ coincide with the coordinates of the reference coordinate axes of the center of the first terminal 33.

Likewise, the coordinates of the reference coordinate axes of the aperture center 54′ of the third aperture 40′ that become the center of the second terminal 48′ coincide with the coordinates of the reference coordinate axes of the center of the first terminal 34.

As a result, by using the deviated first and second alignment marks 52′ and 56′, the locations of the first terminals 33 and 34 of the resistor 35 can be matched in the same plane to the locations of the second terminals 45′ and 48′, that is, the deviated locations of the first and third apertures, thereby completing the location-matching process.

Next, as shown, for example, in FIG. 7B, the first terminals 33 and 34 of the resistor 35 that are adjusted to be located in the same plane are disposed on the second terminals 45 and 48 (the first and third apertures 39 and 40), and are temporarily attached thereon, thereby releasing suction of the robot arm. Here, since the solder portion 46 is formed on the surfaces of the first and third apertures 39 and 40 of the second terminals 45 and 48, the first terminals 33 and 34 of the resistor 35 are correctly disposed on the solder portion 46.

Thereafter, the base substrate 26, on which an electronic component such as the resistor 35 temporarily attached is disposed, is placed in a reflow furnace so as to be subject to a reflow process at a predetermined temperature (e.g. 220° C.), and is subsequently cooled off to solidify the melted solder. Then, an adhesive (e.g. a resin) is filled between the resistor 35 and the protection layer 32. Accordingly, the mounting of an electronic component (e.g. a resistor) on the base substrate is completed (ST111).

Finally, the base substrate 26 is cut into a predetermined size, thereby completing the flexible board 3 on which the wire pattern 27, the resistor 35, and so on are formed and mounted (ST112).

Next, the output terminal 37 of the completed flexible board 3, as shown, for example, in FIG. 2, is electrically connected to the external terminal 21 of the liquid crystal panel 2 via the anisotropic conductive film 36. An illumination device (e.g. backlight), a case, or the like is optionally attached thereon (ST113), thereby completing the liquid crystal device 1 (ST114).

In the aforementioned description, it has been described that the first and third apertures 39 and 40 and the second and fourth apertures 41 and 42 are exposed to light at the same time, and are then subject to a developing process or the like during the formation process. However, the invention is not limited thereto. For example, the first and third apertures 39 and 40 and the second and fourth apertures 41 and 42 may be separately formed in a first aperture-formation process and a second aperture-formation process, respectively. For example, the light-exposure process may be performed at a different time by using the same exposure mask 58. As a result, the invention can be further applied to a variety of liquid crystal devices, and thus the liquid crystal device can be manufactured in the most effective way.

Hereinbefore, the method of manufacturing the liquid crystal device 1 has been described.

In the present embodiment of the invention, the first to fourth apertures 39, 40, 41, and 42 are disposed on the same protection layer 32, the first terminals 33 and 34 of the resistor 35 are respectively electrically connected to the first and third conductors 28 and 29 in the regions C and F surrounded by the fringes 43 and 47 of the first and third apertures 39 and 40. Further, in the regions G and J surrounded by the fringes 49 and 53 of the second and fourth apertures 41 and 42, the locations of the first terminals 33 and 34 are matched to the locations of the first and third apertures 39 and 40 by using the first and second alignment marks 52 and 56. Thus, for example, in the case that the first to fourth apertures 39, 40, 41, and 42 are exposed to light, developed, and formed at the same time by using the exposure mask 58, even if the second and fourth apertures 41 and 42, which are the first and second alignment marks 52 and 56, are deviated due to deviation of the exposure mask, the first and third apertures 39 and 40 are also deviated to that extent. Accordingly, the locations of the first and third apertures 39 and 40 that form the actual second terminals 45 and 48 can maintain a predetermined positional-relation with respect to the locations of the terminals formed by using the first and second alignment marks 52 and 56. In addition, the occurrence of the location deviation between the second terminals 45 and 48 and the terminals formed by using the alignment marks can be easily prevented. Therefore, the locations of the first terminals 33 and 34 can be more correctly matched to the locations of the second terminals 45 and 48 (the first and third apertures 39 and 40), and the liquid crystal device 1 can be further improved in terms of electrical reliability.

Since the first to fourth conductors 28, 29, 30, and 31 are disposed in different regions, and the first to fourth apertures 39, 40, 41, and 42 are respectively disposed in the regions corresponding thereto, the first to fourth apertures 39, 40, 41, and 42 can be used as separate conductors. Further, an electronic component can be mounted on the base substrate 26 in a more flexible manner when designing its disposition, thereby obtaining the effective flexible board 3.

Since the first and third conductors 28 and 29, which are exposed from the protection layer 32 by the first and third apertures 39 and 40, respectively, are coated with the oxidation resistance metal layer 44, the first and third conductors 28 and 29, which are respectively electrically connected to the first terminals 33 and 34 of the resistor 35 that is an electronic component, can be protected against oxidation. In addition, the resistance between the wire 27a electrically connected to the first and third conductors 28 and 29 and the first terminals 33 and 34 of the resistor 35 can be suppressed, resulting in further improved electrical reliability.

Meanwhile, the method of manufacturing the electro-optical device includes a layer-formation process in which the protection layer 32 is formed on the first to fourth conductors, an aperture-formation process in which the first and third apertures 39 and 40 are respectively formed within the regions of the first and third conductors 28 and 29, and the second and fourth apertures 41 and 42 having a predetermined positional-relation with respect to the first and third apertures 39 and 40 are respectively formed within the regions of the second and fourth conductors 30 and 31, and a location-matching process in which the locations of the first and third apertures 39 and 40 are matched to the locations of the first terminals 33 and 34 by using the first and second alignment marks 52 and 56 formed in the regions G and F surrounded by the fringes 49 and 53 of the second and fourth apertures 41 and 42 formed by the aperture-formation process. Therefore, for example, even if the deviated first to fourth apertures 39′, 40′, 41′, and 42′ are formed in the aperture-formation process, the deviated first and third apertures 39′ and 40′ maintain the same positional-relations with respect to the deviated second and fourth apertures 41′ and 42′, respectively. Further, since the first and second alignment marks 52′ and 56′ are formed in the regions surrounded by the fringes of the second and fourth apertures 41′ and 42′, the first and second alignment marks 52′ and 56′ coincide with the deviation of the second and fourth apertures 41 and 42, respectively.

Accordingly, since the terminals formed by the alignment marks maintain the initial positional-relation with respect to the first and third apertures 39 and 40 that are located in the same positions as the actual second terminals 45 and 48, deviation does not occur. For example, creation of a solder ball in an unnecessary place at a time of solder connection can be prevented. Further, a contact resistance can be prevented from increasing when the contact area between the second terminals 45 and 48 and the first terminals 33 and 34 is reduced, thereby improving electrical reliability.

In the aperture-formation process, since the first to fourth apertures 39, 40, 41, and 42 are formed by exposing light thereon at the same time using the integral exposure mask 58, even if the second and fourth apertures 41 and 42 that become the alignment marks are deviated due to deviation of the exposure mask, the first and third apertures 39 and 40 are deviated to the same extent. Accordingly, the terminals formed by the alignment marks can maintain the initial positional-relation with respect to the first and third apertures 39 and 40 that become the second terminals 45 and 48. Further, the second terminals 45 and 48 can be easily prevented from deviating with respect to the terminals formed by the alignment marks. Furthermore, the locations of the first terminals 33 and 34 can be more correctly matched to the locations of the second terminals 45 and 48 (the first and third apertures 39 and 40). As a result, the liquid crystal device 1 can be improved in terms of electrical reliability.

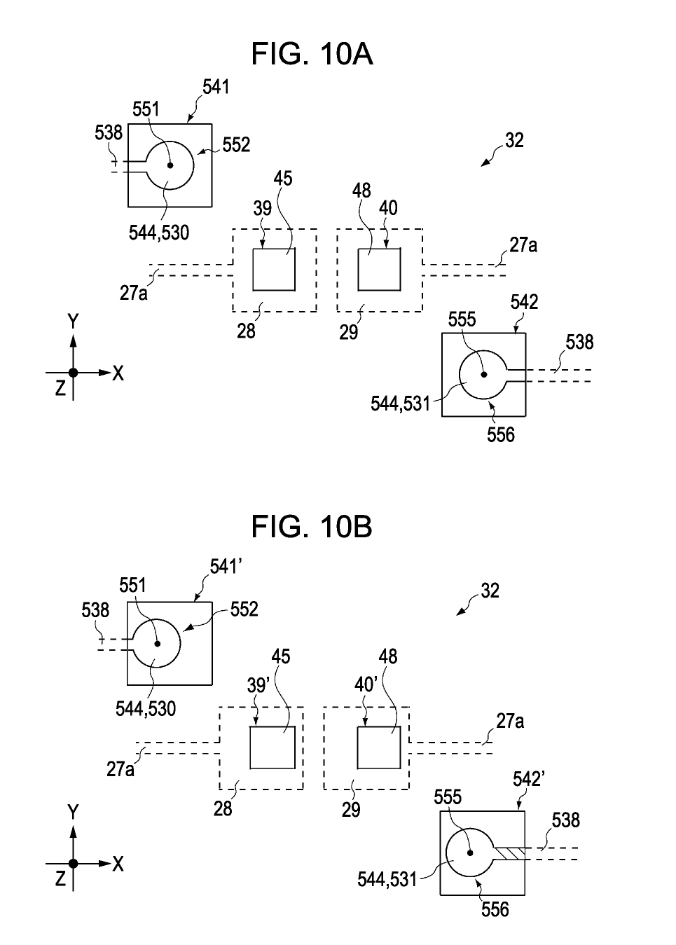

FIG. 10 shows an exposed plating wire when first to fourth apertures 39, 541, 40, and 542 are deviated.

As shown, for example, in FIG. 10A, if a first alignment mark 552 is formed by a patterned second conductor 530 and an oxidation resistance metal layer 544 plated on the surface thereof, in many cases, a plating wire 538 is exposed within a region surrounded by a fringe of a second aperture 541.

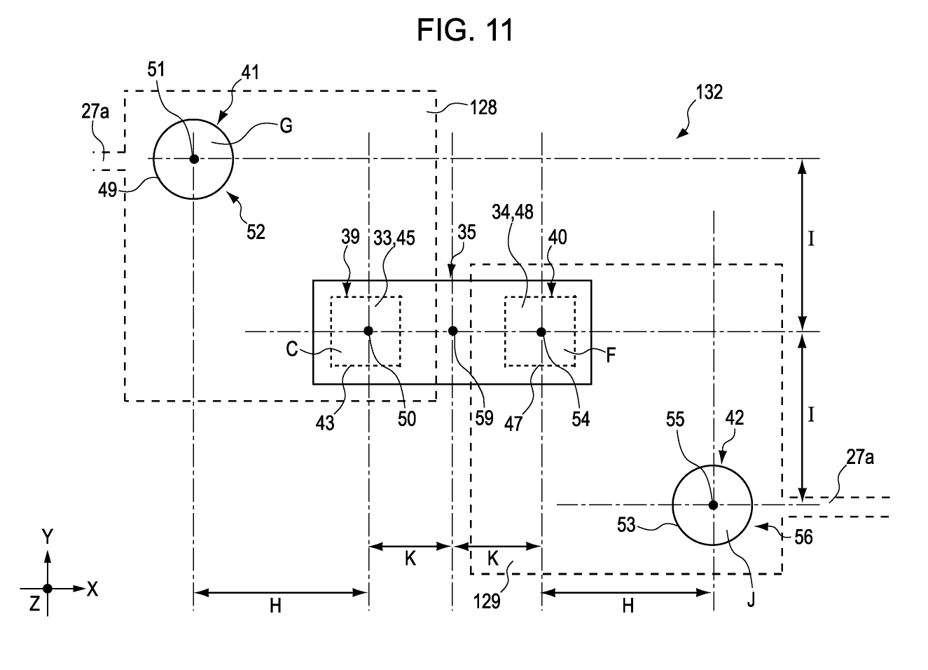

In this case, as shown, for example, in FIG. 10B, if the first to fourth apertures 39, 541, 40, and 542 are deviated to the right (the X-axis direction in FIGS. 11A and B), the plating wire 538 shown in the left side of FIG. 10B is less exposed from a second aperture 541′. Meanwhile, the plating wire 538 shown in the right side of FIG. 10B is more exposed (indicated by oblique lines in FIG. 10B) from a fourth aperture 542′. Accordingly, if the plating wire 538 is excessively exposed, the plating wire 538 is recognized when a location of a corresponding alignment mark center 555 is recognized, and thus the recognition may not be correctly carried out.

To prevent this, in the present embodiment of the invention, for example, the first and second alignment marks 52 and 56 are formed in the regions G and J surrounded by the fringes 49 and 53 of the second and fourth apertures 41 and 42 disposed on the protection layer 32 of the conductors. Therefore, as shown, for example, in FIG. 9, even if the second and fourth apertures 41 and 42 are deviated to become the second and fourth apertures 41′ and 42′, respectively, if the deviation occurs within the conductors, the plating wire 38 is not exposed. Accordingly, as described above, a problem in which the location of the corresponding alignment mark center cannot be correctly recognized due to excessive exposure of the plating wire can be prevented.

### Second Embodiment

Now, a liquid crystal device according to a second embodiment of the invention will be described. In the present embodiment of the invention, unlike the first embodiment of the invention, the first aperture 39 and the second aperture 41, and the third aperture 40 and the fourth aperture 42 are respectively formed within the regions of the same conductors. The following descriptions will focus on this point. In addition, with respect to the first embodiment of the invention, like reference numerals denote like elements, and detailed descriptions thereof will be omitted.

Structure of Liquid Crystal Device

FIG. 11 is a schematic plan view of an electronic component mounted on a flexible board and an alignment mark according to a second embodiment of the invention.

A liquid crystal device 101, as shown, for example, in FIG. 1, includes a liquid crystal panel 2 as an electro-optical panel, and a flexible board 103 as a mount structure connected to the liquid crystal panel 2. Besides the flexible board 103, the liquid crystal device 101 is optionally provided with an illumination device such as a backlight, or additional mechanisms (not shown).

As shown, for example, in FIGS. 1, 2, and 11, the flexible board 103 is formed and mounted with the wire pattern 27 composed of two different conductive layers formed of copper (Cu) or the like formed on the base substrate 26 serving as a board, conductors 128 and 129 which are the two different conductive layers electrically connected to the wire pattern 27, a protection layer 132 laminated on the conductors, and the resistor 35 that is an electric component having the first terminals 33 and 34 as two different terminals respectively electrically connected to the conductors 128 and 129.

As shown, for example, in FIGS. 1 and 2, the wire pattern 27 includes the output terminal 37 that is electrically connected to the external terminal 21 of the first board 5 via the anisotropic conductive film 36, and a wire 27a electrically connected to the first conductors 128 and 129.

The conductors 128 and 129 are substantial rectangular shaped and are parallel with each other on the base substrate 26, with being deviated from each other in the Y-axis direction of FIG. 11, as shown, for example, in FIG. 11. The wire 27a is electrically connected to the conductors 128 and 129, respectively. The conductors 128 and 129 are formed of copper (Cu) or the like.

In the protection layer 132, as shown, for example, in FIG. 11, a photoconductive resin or the like is laminated on the wire 27a and the conductors 128 and 129, the first aperture 39 and the second aperture 41 are formed in different regions within the region of the conductor 128 in such a way that the conductor 128 is exposed, and in the same manner, the third aperture 40 and the fourth aperture 42 are formed in different regions within the region of the conductor 129.

Accordingly, as shown, for example, in FIG. 11, the second terminals 45 and 48 formed by the first and third apertures, and the first and second alignment marks 52 and 56 formed by the second and fourth apertures are respectively formed within the regions of the conductors 128 and 129.

Manufacturing Method of Liquid Crystal Device

Since the method of manufacturing the liquid crystal device 101 having the aforementioned structure is almost the same as in the first embodiment of the invention, descriptions thereof will be omitted.

According to the present embodiment of the invention, the second and fourth apertures 41 and 42 are respectively disposed within the regions of the conductors 128 and 129 in different regions from where the first and third apertures 39 and 40 are disposed, and the conductors 128 and 129 are exposed from the protection layer 132 by the second and fourth apertures 41 and 42. Therefore, a copper foil may be exposed in regions which become the first and second alignment marks 52 and 56, thereby intensifying contrast of reflection light with respect to the surrounding protection layer 132. Further, the locations of the first and second alignment marks 52 and 56 can be correctly recognized by a camera or the like.

In addition, by disposing both the first and second apertures 39 and 41 in the same conductor 128, manufacturing cost can be reduced. This is also applied to the third and fourth apertures 40 and 42.

### Third Embodiment

Now, a liquid crystal device according to a third embodiment of the invention will be described. In the present embodiment of the invention, unlike the first embodiment of the invention, an electronic component mounted on a flexible board have three or more first terminals. The following descriptions will focus on this point. In addition, with respect to the first embodiment of the invention, like reference numerals denote like elements, and detailed descriptions thereof will be omitted.

Structure of Liquid Crystal Device

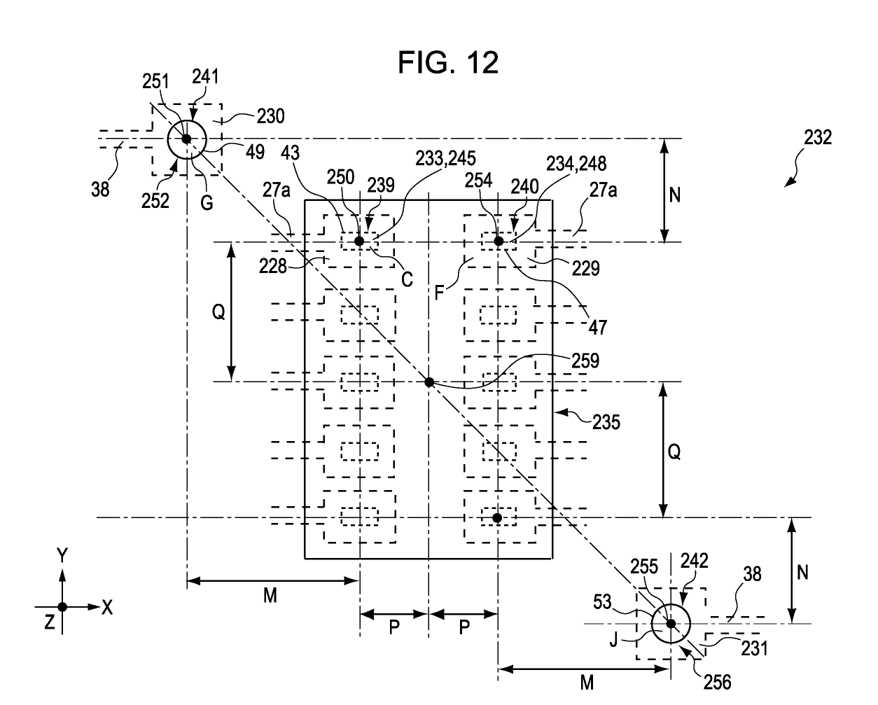

FIG. 12 is a schematic plan view of an electronic component mounted on a flexible board and an alignment mark according to a third embodiment of the invention.

A liquid crystal device 201, as shown, for example, in FIG. 1, includes a liquid crystal panel 2 as an electro-optical panel, and a flexible board 203 as a mount structure connected to the liquid crystal panel 2. Besides the flexible board 203, the liquid crystal device 201 may be optionally provided with an illumination device such as a backlight, or additional mechanisms.

As shown, for example, in FIGS. 1, 2, and 12, the flexible board 203 is formed and mounted with the wire pattern 27 composed of two different conductive layers formed of copper (Cu) or the like formed on the base substrate 26 serving as a board, a first conductor 228 as a first conductive layer electrically connected to the wire pattern 27, a third conductor 229 as a third conductive layer, a second conductor 230 as a second conductive layer, a fourth conductor 231 as a fourth conductive layer, a protection layer 232 laminated on the conductors, and an IC 235 that is an electric component having the first terminals 233 and 234 electrically connected to the first and third conductors 228 and 229, respectively.

The first and third conductors 228 and 229, as shown, for example, in FIG. 12, are substantial rectangular shaped and are parallel with each other on the base substrate 26, so as to face each other in the X-axis of FIG. 12. A wire 27a is electrically connected to the conductors 228 and 229, respectively. Like the first and third conductors 228 and 229, a pair of first and third conductors are disposed in parallel in the Y-axis direction of FIG. 12. The first and third conductors 228 and 229 are formed of copper (Cu) or the like.

In addition, the second and fourth conductors 230 and 231, as shown, for example, in FIG. 12, are respectively formed in the left-upper side of FIG. 12 and in the right-lower side of FIG. 12 in a rectangular shape, with the first and third conductors 228 and 229, or the like being disposed along a diagonal line. Further, a plating wire 38 is electrically connected to the second and fourth conductors 230 and 231, respectively.

In the protection layer 232, as shown, for example, in FIG. 12, a photoconductive resin or the like is laminated on the wire 27a, the first to fourth conductors 228, 229, 230, and 231, or the like. Further, a first aperture 239, a third aperture 240, a second aperture 241, and a fourth aperture 242 are formed in such a way that the first conductor, the third conductor, the second conductor, and the fourth conductor are exposed, respectively.

The first aperture 239, as shown, for example, in FIG. 12, is entirely included inside a region (surrounded by a larger dotted line shown in the left side of FIG. 12) of the first conductor 228, and a region C (surrounded by a smaller dotted line shown in FIG. 12) surrounded by a fringe 43 of the first aperture 239.

The first conductor 228 exposed from the protection layer 232 is plated with an oxidation resistance metal layer 44 such as gold (Au), and is electrically connected to the first terminal 233 as a terminal via the oxidation resistance metal layer 44.

The first conductor 228 exposed from the protection layer 232 and the oxidation resistance metal layer 44 become a second terminal 245 formed in the region C surrounded by the fringe 45 of the first aperture 239. The second terminal 245 allows the first terminal 233 of the IC 235 that is an electronic component, to be electrically connected to the first conductor 228 via a solder portion 46.

The third aperture 240 is almost the same as the first aperture 239, and thus descriptions thereof will be omitted.

The second aperture 241, as shown, for example, in FIG. 12, is formed in a circular shape inside the region (surrounded by a dotted line in the left side of FIG. 12) of the second conductor 230, so as to be entirely included in a region G (surrounded by a solid line of FIG. 12) surrounded by a fringe 49 of the second aperture 241.

The second aperture 241 is positionally related to the first aperture 239. As shown, for example, in FIG. 12, an aperture center 251 of the second aperture 241 is positioned to the left by M with respect to an aperture center 250 of the first aperture 239 in a widthwise direction (the X-axis direction of FIG. 12), and is positioned upwards by N in a lengthwise direction thereof (the Y-axis direction of FIG. 12).

The surface of the second conductor 230 in a region G surrounded by the fringe 49 of the exposed second aperture 241 is plated with the oxidation resistance metal layer 44 such as gold (Au), such that its light reflection rate is different from that of the protection layer 232 around the region G. Accordingly, a shape formed in the region G becomes a first alignment mark 252 that may be used to match the location of the first terminal 233 to the location of the second terminal 245 (the first aperture 239).

Like the second aperture 241, as shown, for example, in FIG. 12, the fourth aperture 242 is formed in a circular shape inside the region (surrounded by a dotted line in the right side of FIG. 12) of the fourth conductor 231, so as to be entirely included in a region J (surrounded by a solid line of FIG. 12) surrounded by a fringe 53 of the fourth aperture 242.

The fourth aperture 242 is positionally related to the third aperture 240. As shown, for example, in FIG. 12, an aperture center 255 of the fourth aperture 242 is positioned to the right by M with respect to an aperture center 254 of the third aperture 240 in a widthwise direction (the X-axis direction of FIG. 11), and is positioned downwards by N+2Q in a lengthwise direction thereof (the Y-axis direction of FIG. 11).

The surface of the fourth conductor 231 in the region J surrounded by the fringe 53 of the exposed fourth aperture 242 is plated with the oxidation resistance metal layer 44 such as gold (Au) like in the region G. A shape formed in the region J becomes a second alignment mark 256 that may be used to match the location of the first terminal 234 to the location of the second terminal 248.

Manufacturing Method of Liquid Crystal Device

The liquid crystal device 201 having the aforementioned structure is different from the first embodiment of the invention in that three or more first or second terminals are disposed. Thus, the following descriptions will focus on a location-matching process in brief. Since other processes are almost the same as in the first embodiment of the invention, descriptions thereof will be omitted.

The locations of the first terminals 233 and 234 of the IC 235 are matched to the locations of the second terminal 245 and 248 (the first and third apertures 239 and 240) in the same plane by the first and second alignment marks 252 and 256 (ST110).

Specifically, as shown, for example, in FIG. 12, after reference coordinates of the X and Y axes are predetermined, reference positions of the apertures 251 and 255 of the second and the fourth apertures 241 and 242 that become the centers of the first and second alignment marks 252 and 256, respectively, are recognized from the reference coordinates by a camera (not shown) or the like. For example, if the center of the first alignment mark 252 is the aperture center 251 of the second aperture 241, and its coordinates are (X1, Y1), then in the same manner, the coordinates of the center of the second alignment mark 256 are (X2, Y2). As a result, the coordinates of the center of a line segment that connects each of the centers of the first and second alignment marks 252 and 256 are determined to be ((X1+X2)/2, (Y1+Y2)/2).

Next, as shown, for example, in FIG. 12, a direction of a line that connects the first terminals 233 and 234 of the IC 235 as an electronic component to be mounted is parallelized to the X-axis. Further, a reference point 259 of the IC 235 is located at the center of a suction hole of a robot arm (not shown) so as to be sucked by the robot arm. For example, in FIG. 12, the reference point 259 is the center of a plurality of first terminals. With respect to the reference point 259 that is the center of the first terminals, for example, the center of the first terminal 233 is positioned to the left by P in the X-axis direction of FIG. 12 from the reference point 259, and is positioned upwards by Q in the Y-axis direction of FIG. 12.

Then, the robot arm sucking the IC 235 as an electronic component moves such that the center of the suction hole can be correctly located at the coordinates ((X1+X2)/2, (Y1+Y2)/2) of the reference coordinate axes. Accordingly, as shown, for example, in FIG. 12, the coordinates of the reference coordinate axes of the aperture center 250 of the first aperture 239 that becomes the center of the second terminal 245 can be determined to be (X1+H, Y1−I) from the relation between aperture center 250 and the aperture center 251.

Meanwhile, the coordinates of the reference coordinate axes of the first terminal 233 of the IC 235 to be matched to the above location becomes (((X1+X2)/2)−P, ((Y1+Y2)/2)+Q). This is obtained from the relation between the reference point 259 and the first terminal 233, where the coordinates of the reference point 259 that are the center between the first terminals of the IC 235 are ((X1+X2)/2, (Y1+Y2)/2). Here, as shown, for example, in FIG. 12, since X2=X1+2M+2P, Y2=Y1−2N−2Q, the coordinates of the reference coordinate axes of the first terminal 233 become (X1+M, Y1−N).

Accordingly, the coordinates of the reference coordinate axes of the aperture center 250 of the first aperture 239 that become the center of the second terminal 245 coincide with the coordinates of the reference coordinate axes of the center of the first terminal 233.

Likewise, the coordinates of the reference coordinate axes of the aperture center 254 of the third aperture 240 that become the center of the second terminal 248 coincide with the coordinates of the reference coordinate axes of the center of the first terminal 234.

As a result, by using the first and second alignment marks 252 and 256, the first terminals 233 and 234 of the IC 235 can be entirely matched in the same plane to the locations of the second terminals 245 and 248 (the first and third apertures 239 and 240).

Hereinbefore, the method of manufacturing the liquid crystal device 201 has been described.

According to the present embodiment of the invention, a plurality of the first and third apertures 239 and 240 are disposed, and two or more of the second and fourth apertures 241 and 242 are disposed in different regions from where the plurality of first and third apertures are surrounded. Therefore, the second terminals 245 and 248 formed by the first and third apertures 239 and 240 can easily avoid from deviation with respect to the terminals formed by the first and second alignment marks 252 and 256, thereby improving electrical reliability. Moreover, even when a plurality of first terminals are used, the second and fourth apertures 241 and 242, which form the first and second alignment marks 252 and 256, may be disposed outside a region surrounding the plurality of first terminals along a diagonal line. Thus, the first terminals 233 and 234 can be correctly matched to the locations of the second terminals 245 and 248.

### Fourth Embodiment

Now, a liquid crystal device according to a fourth embodiment of the invention will be described. In the present embodiment of the invention, unlike the first embodiment of the invention, a plurality of electronic components such as the resistor 35 are mounted on a flexible board. The following descriptions will focus on this point. In addition, with respect to the first embodiment of the invention, like reference numerals denote like elements, and detailed descriptions thereof will be omitted.

Structure of Liquid Crystal Device

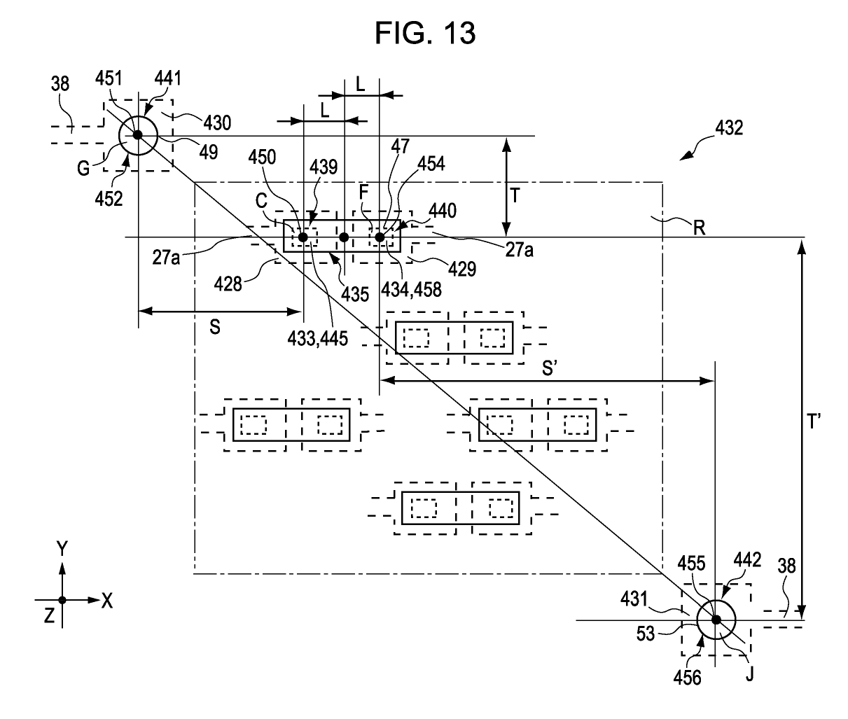

FIG. 13 is a schematic plan view of an electronic component mounted on a flexible board and an alignment mark according to a fourth embodiment of the invention.

A liquid crystal device 401, as shown, for example, in FIG. 1, includes a liquid crystal panel 2 as an electro-optical panel, and a flexible board 403 as a mount structure connected to the liquid crystal panel 2. Besides the flexible board 403, the liquid crystal device 401 may be optionally provided with an illumination device such as a backlight, or additional mechanisms.

As shown, for example, in FIGS. 1, 2, and 13, the flexible board 403 is formed and mounted with the wire pattern 27 composed of two different conductive layers formed of copper (Cu) or the like formed on the base substrate 26 serving as a board, first to fourth conductors 428, 429, 430, and 431 as first to fourth conductive layers electrically connected to the wire pattern 27, a protection layer 432 laminated on the conductors, and a plurality of resistors 435 that are electronic components having first electrodes 433 and 434 electrically connected to and the first and third conductors 428 and 429, respectively.

The first and third conductors 428 and 429, as shown, for example, in FIG. 13, are substantial rectangular shaped and are parallel with each other on the base substrate 26, so as to face each other in the X-axis of FIG. 13. A wire 27a is electrically connected to the conductors 428 and 429, respectively. Like the first and third conductors 428 and 429, a pair of first and third conductors are disposed in different regions so as to be parallel to the Y-axis direction of FIG. 13. The first and third conductors 428 and 429 are formed of copper (Cu) or the like.

In addition, the second and fourth conductors 430 and 431, as shown, for example, in FIG. 13, are respectively formed in the left-upper side of FIG. 13 and in the right-lower side of FIG. 13 in a rectangular shape, so as to be disposed along a diagonal line of a region R (surrounded by a dash dot line of FIG. 13) surrounding the first and third conductors 428 and 429. Further, a plating wire 38 is electrically connected to the second and fourth conductors 430 and 431, respectively.

In the protection layer 432, as shown, for example, in FIG. 13, a photoconductive resin or the like is laminated on the wire 27a and the first to fourth conductors 428, 429, 430, and 431. Further, the first to fourth apertures 439, 440, 441, and 442 are formed in such a way that the first to fourth conductors are exposed, respectively.

The first aperture 439, as shown, for example, in FIG. 13, is entirely included inside a region (surrounded by a larger dotted line shown in the left side of FIG. 13) of the first conductor 428, and a region C (surrounded by a smaller dotted line shown in FIG. 13) surrounded by a fringe 43 of the first aperture 439.

The first conductor 428 exposed from the protection layer 432 is plated with an oxidation resistance metal layer 44 such as gold (Au), and is electrically connected to the first terminal 433 as a terminal via the oxidation resistance metal layer 44.

The first conductor 428 exposed from the protection layer 432 and the oxidation resistance metal layer 44 become a second terminal 445 formed in the region C surrounded by the fringe 42 of the first aperture 439. The second terminal 445 allows the first terminal 433 of the resistors 435 that are electronic components, to be electrically connected to the first conductor 428 via a solder portion 46.

The third aperture 440 is almost the same as the first aperture 439, and thus descriptions thereof will be omitted.

The second aperture 441, as shown, for example, in FIG. 13, is formed in a circular shape inside the region (surrounded by a dotted line in the left side of FIG. 13) of the second conductor 430, so as to be entirely included in a region G (surrounded by a solid line of FIG. 13) surrounded by a fringe 49 of the second aperture 441.

The second aperture 441 is positionally related to the first aperture 439. As shown, for example, in FIG. 13, an aperture center 451 of the second aperture 441 is positioned to the left by S with respect to an aperture center 450 of the first aperture 439 in a widthwise direction (the X-axis of FIG. 13), and is positioned upwards by T in a lengthwise direction thereof (the Y-axis direction of FIG. 13).

The surface of the second conductor 430 in a region G surrounded by the fringe 49 of the exposed second aperture 441 is plated with the oxidation resistance metal layer 44 such as gold (Au), such that its light reflection rate is different from that of the protection layer 432 around the region G. Accordingly, a shape formed in the region G becomes a first alignment mark 452 that may be used to match the location of the first terminal 433 to the location of the second terminal 445 (the first aperture 439).

Like the second aperture 441, as shown, for example, in FIG. 13, the fourth aperture 442 is formed in a circular shape inside the region (surrounded by a dotted line in the right side of FIG. 13) of the fourth conductor 431, so as to be enter entirely within a region J (surrounded by a solid line of FIG. 13) surrounded by a fringe 53 of the fourth aperture 442.

The fourth aperture 442 is positionally related to the third aperture 440. As shown, for example, in FIG. 13, an aperture center 455 of the fourth aperture 442 is positioned to the right by S′ with respect to an aperture center 454 of the third aperture 440 in a widthwise direction (the X-axis direction of FIG. 13), and is positioned downwards by T′ in a lengthwise direction thereof (the Y-axis direction of FIG. 13).

The surface of the fourth conductor 431 in the region J surrounded by the fringe 53 of the exposed fourth aperture 442 is plated with the oxidation resistance metal layer 44 such as gold (Au) like in the region G. A shape formed in the region J becomes a second alignment mark 456 that may be used to match the location of the first terminal 434 to the location of the second terminal 448 (the third aperture 440).

Manufacturing Method of Liquid Crystal Device

The method of manufacturing the liquid crystal device 401 having the aforementioned structure is almost the same as in the first embodiment of the invention, thus descriptions thereof will be omitted.

According to the present embodiment of the invention, a plurality of the first and third apertures 439 and 440 are disposed, and the second and fourth apertures 441 and 442 are disposed in different regions from where the plurality of first and third apertures are surrounded, for example, the region R of FIG. 13. Therefore, the second terminals 445 and 448 formed by the first and third apertures can easily avoid from deviation with respect to the terminals formed by the first and second alignment marks 452 and 456, thereby improving electrical reliability. Moreover, as shown, for example, in FIG. 13, even when the plurality of resistors 435 are used as electronic components, the second and fourth apertures 441 and 442, which form the first and second alignment marks 452 and 456, may be respectively disposed outside the region R surrounding the plurality of first terminals along a diagonal line. Thus, the first terminals 433 and 434 can be correctly matched to the locations of the second terminals 445 and 448 (the first and third apertures 439 and 440).

### Fifth Embodiment

Now, an electronic apparatus having the aforementioned liquid crystal devices 1, 101, 201, and 401 according to a fifth embodiment of the invention will be described. In addition, with respect to the first embodiment of the invention, like reference numerals denote like elements, and detailed descriptions thereof will be omitted.

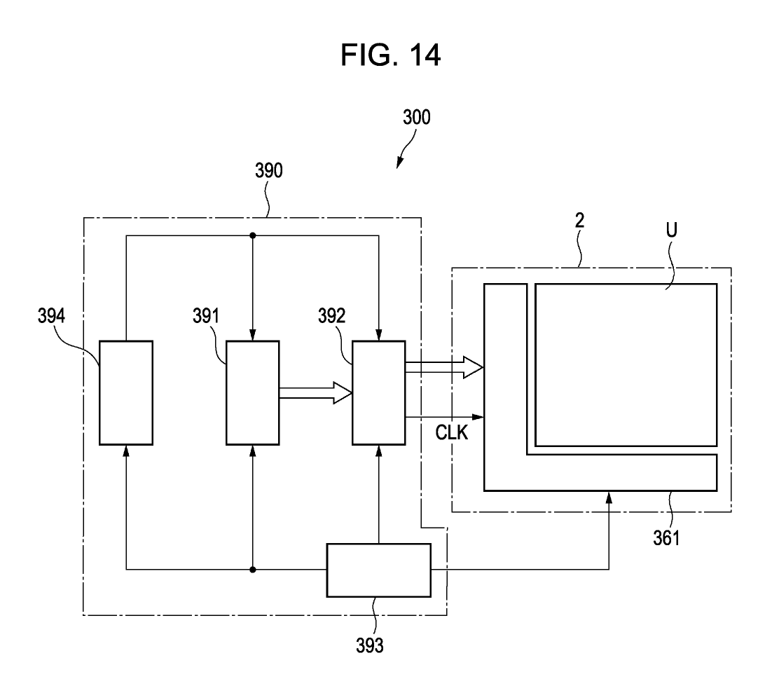

FIG. 14 is a schematic block diagram showing a structure of a display control system of an electronic apparatus according to a fifth embodiment of the invention.

As a display control system, an electronic apparatus 300, as shown, for example, in FIG. 14, includes a liquid crystal panel 2 and a display control circuit 390. The display control circuit 390 includes a display information output source 391, a display information processing circuit 392, a power source circuit 393, and a timing generator 394.

The liquid crystal panel 2 includes a driving circuit 361 that drives a display region U.

The display information output source 391 includes a memory unit such as a ROM (Read Only Memory) or a RAM (Random Access Memory), a storage unit such as a magnetic recording disk or an optical recording disk, and a tuned circuit that tunes and outputs a digital image signal. Furthermore, the display information output source 391 provides display information to the display information processing circuit 392 in the format of a predetermined image signal, based on various clock signals generated by the timing generator 394.

The display information processing circuit 392 includes a variety of circuits such as a serial-parallel converting circuit, an amplifying and inverting circuit, a rotation circuit, a gamma correction circuit, and a clamp circuit. The display information processing circuit 392 processes input display information, and provides its image information to the driving circuit 361 along with a clock signal CLK. The power source circuit 393 supplies a predetermined voltage to each of the above components.

According to the present embodiment of the invention, the electronic apparatus 300 employs the liquid crystal device 1 that can easily prevent the occurrence of a location deviation between an actual terminal and a terminal formed by an alignment mark, thereby improving electrical reliability. Thus, a downsized high-performance product can be achieved with improved reliability.

In particular, with the recent demand for a more reliable high-performance electronic apparatus, the invention providing the electronic apparatus becomes more significant.

Specifically, besides a mobile phone or a personal computer, examples of the electronic apparatus include a touch panel having a liquid crystal device, a projector, a liquid crystal TV, a viewfinder type or monitor direct-view type video tape recorder, a car navigation, a pager, an electronic scheduler, a calculator, a word processor, a workstation, a video telephone, or a POS terminal. Not to mention, the aforementioned liquid crystal devices 1, 101, 201, and 401 can be used as a display for the electronic apparatus.

The electro-optical device and the electronic apparatus are not limited to the aforementioned embodiments, and various changes in form and details may be made therein without departing from the spirit and scope of the invention. Further, each of the embodiments may be combined without departing from the spirit and scope of the invention.

While the invention has been particularly shown and described with reference to exemplary embodiments thereof, the invention is not limited to any one of the aforementioned embodiments, and various changes in form and details may be made therein without departing from the spirit and scope of the invention.

Although a thin film transistor active matrix type liquid crystal device has been described above, the invention is not limited thereto. For example, a thin film diode active matrix type or passive matrix type liquid crystal device may be used. Accordingly, various types of liquid crystal devices can easily prevent the occurrence of location deviation between an actual terminal and a terminal formed by an alignment mark, thereby improving electrical reliability.

In addition, although it has been described that the X-driver 17 and the Y-driver 18 as a COG (Chip On Glass), the invention is not limited thereto. For example, a COF (Chip On Film) mounted on the flexile board 3 may be used. Accordingly, various types of liquid crystal devices can easily prevent the occurrence of location deviation between an actual terminal and a terminal formed by an alignment mark, thereby improving electrical reliability.

In addition, although it has been described that an electronic component is mounted on the flexible board, the invention is not limited thereto. For example, the electronic component may be mounted on a glass board or resist board of the liquid crystal panel 2. Accordingly, the liquid crystal device can have more improved electrical reliability.

In addition, although it has been described that the electronic component is sucked by a robot arm or the like, and the electronic element moves to a specific position determined by two alignment marks to match its location, the invention is not limited thereto. For example, a board to be mounted may move to a specific position by using the alignment marks, or both the board and the electronic component may move to match their locations. Accordingly, various types of liquid crystal devices can easily prevent the occurrence of location deviation between an actual terminal and a terminal formed by an alignment mark, thereby improving electrical reliability.

In addition, although it has been described that the first to fourth apertures are formed after being disposed, the invention is not limited thereto. For example, if difference between a material of the base substrate and a material of the protection layer can be recognized, both or either one of the second and fourth apertures used as the alignment mark may be directly formed on the base substrate. Accordingly, various types of liquid crystal devices can easily prevent the occurrence of location deviation between an actual terminal and a terminal formed by an alignment mark, thereby improving electrical reliability.

In addition, although it has been described that the first and second alignment marks, and a terminal on a board corresponding to the terminal of the electronic component are all formed by regions surrounded by the fringes of the first to fourth apertures, the invention is not limited thereto. For example, only either one of the first and second alignment marks, and a portion of a plurality of terminals on the board may be formed by regions surrounded by the fringes of the first to fourth apertures. Accordingly, various types of liquid crystal devices can easily prevent the occurrence of location deviation between an actual terminal and a terminal formed by an alignment mark, thereby improving electrical reliability.

What is claimed is:

1. A mount structure comprising:
a board;
a conductive layer disposed on the board;
a protection layer that is disposed on at least the conductive layer, and has first and second apertures disposed within a region in which the conductive layer is disposed; and
an electronic component that is mounted on the board, and has a terminal electrically connected to the conductive layer in a region surrounded by a fringe of the first aperture,
wherein a region surrounded by a fringe of the second aperture is an alignment mark that is used to match the location of the terminal of the electronic apparatus to the location of the first aperture.

2. A mount structure comprising:
a board;
a conductive layer disposed on the board;
a protection layer having a first aperture that is disposed within a region in which the conductive layer is disposed, and a second aperture that is disposed in a different region from where the conductive layer is disposed on the board; and
an electronic component that is mounted on the board, and has a terminal electrically connected to the conductive layer in a region surrounded by a fringe of the first aperture,
wherein a region surrounded by a fringe of the second aperture is an alignment mark that is used to match the location of the terminal of the electronic apparatus to the location of the first aperture.

3. An electro-optical device comprising:
a board electrically connected to an electro-optical panel;
a conductive layer disposed on the board;
a protection layer that is disposed on at least the conductive layer, and has first and second apertures disposed within a region in which the conductive layer is disposed; and
an electronic component that is mounted on the board, and has a terminal electrically connected to the conductive layer in a region surrounded by a fringe of the first aperture,
wherein a region surrounded by a fringe of the second aperture is an alignment mark that is used to match the location of the terminal of the electronic apparatus to the location of the first aperture.

4. The electro-optical device according to claim 3, wherein the second aperture is disposed in a different region from where the first aperture is disposed within a region in which the same conductive layer having the first aperture is disposed.

5. The electro-optical device according to claim 3,
wherein the conductive layer includes first and second conductive layers disposed in different regions, and
wherein the first aperture is disposed within a region in which the first conductive layer is disposed, and the second aperture is disposed within a region in which the second conductive layer is disposed.

6. The electro-optical device according to claim 3,
wherein the conductive layer exposed through the protection layer by the first aperture is coated with an oxidation resistance metal layer.

7. The electro-optical device according to claim 3, further comprising a second conductive layer that does not overlap the conductive layer,
wherein the protection layer is disposed at least on the second conductive layer, and has third and fourth apertures which do not overlap each other within a region in which the second conductive layer is disposed,
wherein the electronic component has a second terminal electrically connected to the second conductive layer in a region surrounded by a fringe of the third aperture, and
wherein, along with a region surrounded by a fringe of the second aperture, a region surrounded by a fringe of the fourth aperture is an alignment mark that is used to match the locations of the terminal of the electronic apparatus and the second terminal to the locations of the first and third apertures, respectively.

8. The electro-optical device according to claim 3, further comprising third and fourth conductive layers that overlap neither the conductive layer nor each other,
wherein the protection layer is disposed on the third and fourth conductive layers, and has a third aperture disposed within a region in which the third conductive layer is disposed, and a fourth aperture disposed within a region in which the fourth conductive layer is disposed,
wherein the electronic component has a second terminal electrically connected to the third conductive layer in a region surrounded by a fringe of the third aperture, and
wherein, along with a region surrounded by the fringe of the second aperture, a region surrounded by the fringe of the fourth aperture is an alignment mark that is used to match the locations of the terminal of the electronic apparatus and the second terminal to the locations of the first and third apertures, respectively.

9. A method of manufacturing an electro-optical device having an electro-optical panel to which a board mounted with an electronic component is electrically connected, the method comprising:
a formation process in which a conductive layer is formed on the board;
a layer-formation process in which a protection layer is formed on the conductive layer formed in the formation process;
an aperture-formation process in which first and second apertures are formed in the protection layer within a region of the conductive layer such that the first and second apertures do not overlap each other;
a location-matching process in which the location of a terminal of the electronic component electrically connected to the conductive layer in a region surrounded by a fringe of the first aperture is matched to the location of the first aperture by using a first alignment mark formed in a region surrounded by a fringe of the second aperture, and
a mounting process in which the electronic component that has undergone the location-matching process is mounted on the board.

10. The method according to claim 9, wherein, in the aperture-formation process, the first aperture and the second aperture are exposed to light at the same time by using an integral exposure mask.

11. The method according to claim 9,
wherein, in the formation process, a second conductive layer is formed that does not overlap the conductive layer,
wherein, in the layer-formation process, the protection layer is formed on the second conductive layer formed in the formation process,
wherein, in the aperture-formation process, third and fourth apertures are formed in the protection layer within a region of the second conductive layer, such that the third and fourth apertures do not overlap each other, and
wherein, in the location-matching process, the location of a second terminal electrically connected to the second conductive layer is matched to the locations of the first and third apertures in a region surrounded by the terminal of the electronic component and a fringe of the third aperture, by using the first alignment mark and a second alignment mark formed in a region surrounded by the fringe of the fourth aperture.

12. The method according to claim 9,
wherein, in the formation process, third and fourth conductive layers are formed such that the third and fourth conductive layers overlap neither the conductive layer nor each other,
wherein, in the layer-formation process, the protection layer is formed on the third and fourth conductive layers formed in the formation process,
wherein, in the aperture-formation process, third and fourth apertures are formed in the protection layer respectively within the region in which the third conductive layer is formed and within the region in which the fourth conductive layer is formed, and
wherein, in the location-matching process, the location of the second terminal electrically connected to the third conductive layer in a region surrounded by the terminal of the electronic component and the fringe of the third aperture is matched to the locations of the first and third apertures by respectively using the first alignment mark and a second alignment mark formed in a region surrounded by the fringe of the fourth aperture.

13. An electronic apparatus having the electro-optically device according to claim 3.
